(19) United States
(12) Patent Application Publication
(10) Pub. No.: US 2003/0065942 A1
(43) Pub. Date: Apr. 3, 2003

(54) Method and apparatus for actively managing security policies for users and computers in a network

(76) Inventors: David J. Lineman, Houston, TX (US); Scott R. Wierschem, Houston, TX (US)

Correspondence Address: HOWREY SIMON ARNOLD & WHITE, 750 Bering Drive, Houston, TX, 77057-2198, US

(21) Appl. No.: 09/966,006

(22) Filed: Sep. 28, 2001

(51) Int. Cl. G06F 11/30

(52) U.S. Cl. 713/201

(57) ABSTRACT

A software program capable of creating and managing security policies on a network is disclosed. When a computer administrator selects a set of security controls based on the selected policy, it automatically communicates the controls to computer systems in the network capable of understanding this information. The computer systems can either be audited against this policy or altered to conform to the selected policy. Such changes might include enabling, disabling, deleting, moving or reassigning users, files or objects within the network. The invention further communicates this policy to individuals responsible for understanding the policy via a software program and tracks their reading and understanding of the policy via the same software.

### FIELD OF THE INVENTION

The disclosed software relates in general to computer networks, and more specifically to a method and apparatus for actively managing the security policies for users and computers in a network.

### BACKGROUND OF THE INVENTION

In modem computing environments, the management of information assets of a company is a complex and expensive task. Information assets may include, but are not limited to, customer data, financial transaction records, internal technical documents, or competitive information. Exposure of this sensitive data to the wrong parties can mean lost revenue, damage to corporate image, a decline in stock price, and even legal action against the company.

While technology continues to make advances in protecting computers and networks, technical solutions fail to solve the security risks associated with information. Recent computer crime statistics show that most security breaches occur because people do not understand how to use computing resources in a secure fashion. An example is a computer user who, unaware that he is not supposed to open email attachments, inadvertently launches a computer virus into his computer. Thus, it is the combination of people and technology together that creates the risk to information assets.

In order to address security risks, professionals skilled in the art of protecting information will commonly create a security policy, which is a high-level statement of management's intent to protect company information and assets. Based on this policy, security professionals will then select a more detailed set of standards, which are used to protect company information based on the perceived risk to the asset. In most company environments, these standards are comprised of two subsets. The first subset can be called technical standards that address the configuration of computing assets such as servers, databases, routers or firewalls. For example, a technical standard might specify that passwords be set to expire after 90 days. The second subset can be called guidelines that address the behaviors of people in the company. For example, a guideline might specify that users not download certain software from the Internet. For a company to address all information security risks, both technical procedures and human guidelines must be established and communicated.

Security standards are typically embodied in a security policy document that addresses certain security issues, such as physical security, laptop security or acceptable Internet use. Once approved by necessary management personnel, these security documents are then distributed to individuals in the organization by various means to insure that they are read and understood. Communicating and training users on the security policy therefore becomes crucial. In fact, many government regulations require security training to ensure the safety of public data, and companies subject to these regulations are routinely audited for compliance. System administrators responsible for managing the computing systems must also act on security policy documents. The system administrator must understand the policy and then alter (manually in most cases) the security parameters of necessary computers and networks to enforce the policy.

In the prior art, several challenges make the creation and management of these security policies difficult. First, creating the security policy is typically a labor-intensive process requiring significant skill in the art of information security. Second, selecting an appropriate set of detailed controls for each type of computing platform to enforce the security policy requires even more detailed analysis by a different security professional skilled in the art of protecting that particular type of system. Once selected, these controls are then broken down into a set of manual steps that must be performed by a system administrator responsible for the platforms being protected. Third, there is no direct relationship between the policies in the written policy documents and the controls used to enforce them on the machines. In the prior art, a mismatch often exits between the written polices and what is actually enforced on the computer systems. This is referred to as a compliance gap.

To further complicate the problem, the human procedures contained in these documents need to be distributed to each user of company computer resources. For legal and auditing reasons, a company must be able to verify that these policy documents have been read and understood by the users. This is typically done by distributing printed policy documents to each user, and having the user sign an agreement stating that they have read and understood the policy. Not only is the procedure expensive, but there is no way for the company to get a report at any given time on how many and which users have done this. Further, when the policies need to be updated to address a new security risk (for example, a new type of e-mail macro virus), the procedure must be repeated. In large international companies with tens of thousands of users who speak different languages, the procedure is so inefficient and costly that it is often not done, leaving the company vulnerable to a compliance gap and a security risk.

### SUMMARY OF THE INVENTION

The disclosed software is directed to electronically creating a security policy document, which contains appropriate controls required to enforce the security policy on various computing platforms. The disclosed software creates a direct link between the security policy documents that are created and distributed to people and the controls sent to computers on the network. In other words, the disclosed software eliminates the manual task of communicating these controls to various persons in the company responsible for administering these computer platforms. The appropriate controls are communicated via a computer network by a security manager that is able to measure the compliance of these platforms against the controls. The disclosed software also communicates a set of security policies, standards and guidelines that must be understood by people to the various individuals of a company via a software program. Furthermore, the disclosed software tracks their access to the security policy document and measures their understanding of the policy. Thus, the compliance of both people and platforms may be measured through one software program, greatly reducing the cost of deploying and enforcing security and the overall risk to company information.

The foregoing summary is not intended to summarize each potential embodiment, or every aspect of the invention disclosed herein, but merely to summarize the appended claims.

### BRIEF DESCRIPTION OF THE DRAWINGS

The foregoing summary, a preferred embodiment and other aspects of the disclosed software will be best understood with reference to a detailed description of specific embodiments of the invention, which follows, when read in conjunction with the accompanying drawings, in which:

FIG. 1 illustrates an example of a network benefiting from the disclosed software.

FIG. 2 illustrates a flowchart showing steps for actively managing security policies for computer systems and users with the disclosed software.

FIG. 3 illustrates an exemplary screen of a menu interface for the policy management program.

FIGS. 4A-B illustrate exemplary screen of a Policy Wizard for creating and editing a security policy document.

FIGS. 5A-B illustrate exemplary screens of a policy editor for creating and editing a security policy document.

FIGS. 6A-B illustrate an Extensible Markup Language representation of a security policy document linking the policy in human-readable and machine-readable forms.

FIGS. 7A-D illustrate exemplary screens of a policy quiz editor for creating and editing a security policy quiz.

FIGS. 8-9 illustrate exemplary screens of stages for reviewing and preparing the security policy document before publishing.

FIGS. 10A-C illustrate exemplary screens of a user web site providing access to published security policy documents and quizzes with an illustrative examples.

FIGS. 11A-D illustrate exemplary screens of user compliance reports for published security policies from within the policy management program.

FIG. 12 illustrates an exemplary screen of an edit security checkup template of the security management program.

FIGS. 13A-C illustrate exemplary screens of the security management program for verifying the machines in the network comply with the published security policy.

FIGS. 14 illustrates an exemplary screen of the security management program having detect rules for verifying compliance of the computer systems with security policies.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the scope of the invention as defined by the appended claims.

### DETAILED DESCRIPTION OF THE INVENTION

In the disclosure that follows, in the interest of clarity, not all features of actual implementations are described. It will of course be appreciated that in the development of any such actual implementation, as in any such project, numerous engineering and design decisions must be made to achieve the developers' specific goals and subgoals (e.g., compliance with mechanical- and business-related constraints), which will vary from one implementation to another. Moreover, attention will necessarily be paid to proper engineering and design practices for the environment in question. It will be appreciated that such a development effort might be complex and time-consuming, but would nevertheless, given this disclosure, be a routine undertaking for those of skill in the art.

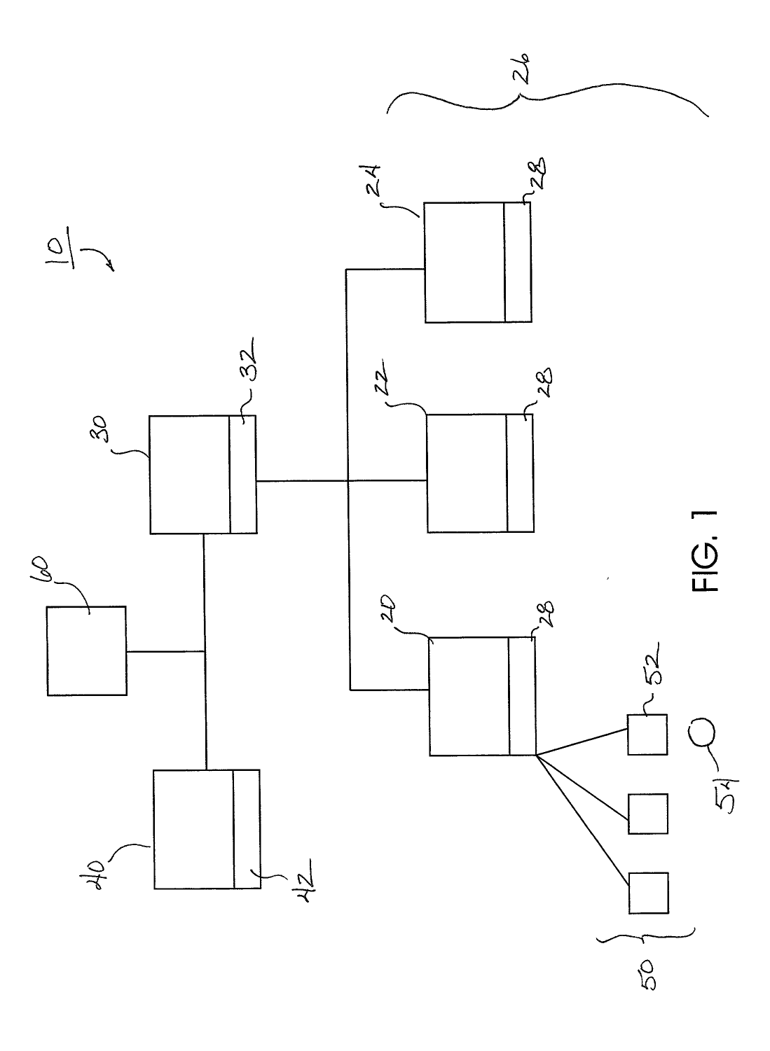

Referring to FIG. 1, a typical, “enterprise-sized” network 10 is illustrated that can be enhanced by the inventive policy management features of the disclosed software system. The network 10, for example, includes systems from three different platform groups 20, 22 and 24, a security server 30, a policy server 40, and a plurality of desktop personal computers 50. Each of the platform groups 20, 22, 24 in the network 10 may be represented by multiple computer systems or a combination of computer systems 26, such as Windows NT, Unix, and AS/400. The computer systems 26 for the platform groups 20, 22, 24 may include servers, databases, routers and appliances, among other machines or devices. The disclosed software, however, works just as well in a homogenous network using only a single computer system, such as Windows NT.

The security server 30 is loaded with a first portion of the disclosed software, referred to as the security management program 32 herein. The security server 30 constitutes the computer from which a professional involved with information security, such as a systems administrator, will set and audit the security policies on the computer systems 26 of the platform groups 20, 22, 24. A commercial embodiment of the disclosed security management program 32 includes the “VigilEnt Enterprise Security Manager” interface software package currently marketed by PentaSafe Security Technologies, Inc.

The policy server 40 is loaded with a second portion of the disclosed software, referred to as the policy management program 42 herein. The policy server 40 constitutes the computer from which the security administrator or other computer user may create and publish security policies as described in more detail below. A commercial embodiment of the disclosed policy management program 42 includes the “VigilEnt Policy Center” software package also recently marketed by PentaSafe Security Technologies, Inc.

Using the desktop computers 50, the users 54 may access the corporate network 10. These desktop computers 50 may employ a software program known as a Web Browser 52, such as Microsoft Internet Explorer, to view information presented from the policy server 40, although other types of software may be used to achieve this same purpose.

Security policy data is stored in data services engine 60, which is preferably a Microsoft SQL server, but also may be a server produced by other companies such as IBM and Oracle. Because the disclosed software enables the administrator to make any administrative modification as if seated at the computing systems 26 of the platform groups 20, 22, or 24, other software, referred to as agent software 28 herein, is installed on the computer systems or servers 26 within the network 10 (as will be disclosed in more detail later) to allow the administrator to appropriately control and monitor these systems at a distance. A commercial embodiment of the agent software 28 suitable for installation on the computer systems or servers 26 includes the “VigilEnt Security Agent” software package currently marketed by PentaSafe Security Technologies, Inc.

In the disclosure that follows, reference to the above-described network 10 will be made using an exemplary computing environment upon which the disclosed software may operate. It is understood, however, that the disclosed software is not limited to the particular embodiment of the network 10 used herein, but may apply to less or more extensive networks. For example, although the present embodiment comprises security management program 32 and the policy management program 42 loaded on separate servers 30 and 40, the disclosed software may comprise a single software program incorporating both of these software features loaded on one computer or server in the network 10. The particular implementation of the disclosed software may depend on the configuration of the network for which it is used or the specific needs of the security administrators using the disclosed software.

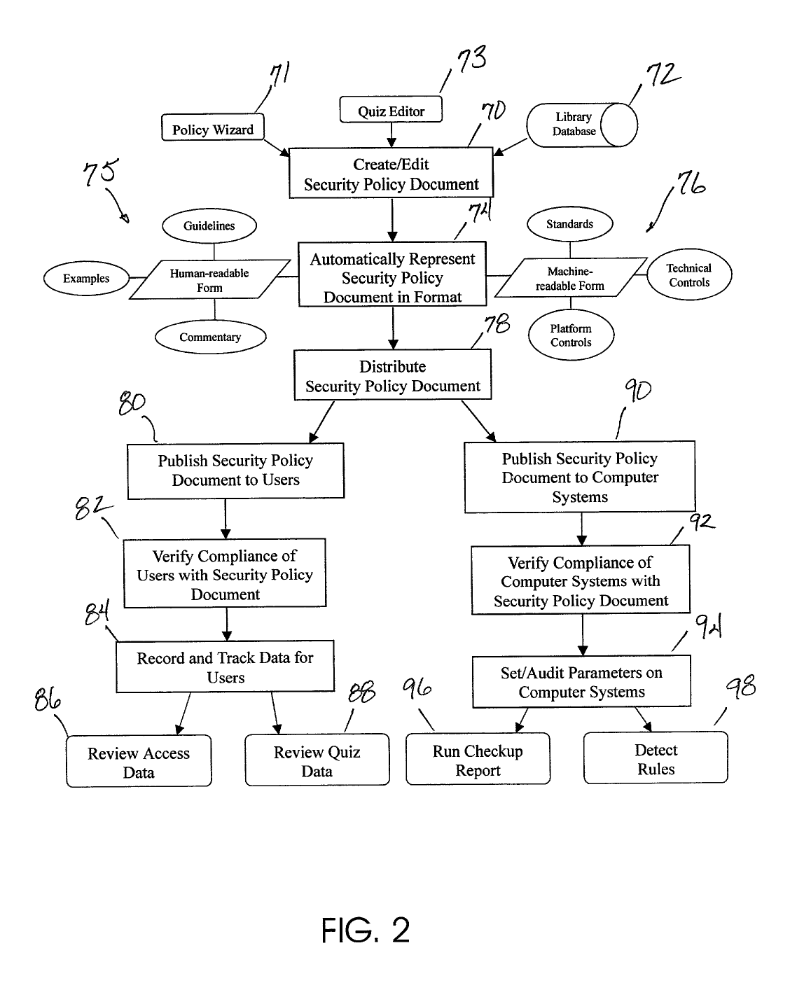

Referring to FIG. 2, a flowchart illustrates steps for actively creating, managing and enforcing security policies for computer systems 26, personal computers 50, and users 54 in accordance with the disclosed software. The disclosed software enables a security administrator to create and edit a security policy document (block 70). To assist in the creation of the security policy document, the disclosed software may include a Policy Wizard 71, enabling a security administrator to use a library database 72 to construct the security policy document. Additionally, a quiz editor 73 may be provided, which allows the administrator to design questions for testing a user's understanding of the security policies in the security policy document.

The disclosed software automatically represents the security policy document in a structured data representation having two forms (block 74). The structured data representation includes a human-readable form (block 75) and includes a machine-readable form (block 76). The human-readable form contains security guidelines reflecting the security policies in the document. The security guidelines address the behaviors of the users 54 in the network 10. To strengthen the user's comprehension of the security policies in the document, the human-readable form may also include commentary, examples, and test questions that further explain and illustrate the guidelines.

The machine-readable form contains the technical standards reflecting the security policies in the document. The technical standards address the configuration of the computer systems 26 of the network 10. The technical standards include technical controls required to audit or to configure the computer systems 26 to implement the technical standards. The technical controls may also include relevant data or parameters to be communicated across the various platform groups 20, 22, 24 that make up the network 10.

The disclosed software then distributes the security policy document (block 78) to both users (block 80) and to the computer systems (block 90). In publishing the security policy document to the users, the users are allowed to access the human-readable form via the network 10. For example, the users may access the security policy on the policy server 40 using the Web Browser 52.

As noted previously, a limitation in the prior art has been the ability to determine which users in the organization have read and understood the security policy documents. Therefore, once the security policy document is published to the users, the disclosed software enables the administrator to verify the degree of compliance with the security policy in the document demonstrated by the users (block 82). The disclosed software does this by recording and tracking data on the users (block 84). The data includes access data, such as a timestamp reflecting when a particular user has acknowledged reviewing the security policy document. The data also includes quiz data, such as scores from a quiz. The quiz is associated with the security policy document and is designed to test the user's knowledge thereof. The data is stored in a logged file and also within the policy server 40, which the administrator may access to assess the degree of compliance and understanding of the security policy demonstrated by the users (blocks 86 and 88).

Independent from or in combination with the aforementioned aspect of the disclosed software, the disclosed software also publishes or transmits the security policy document to the computer systems 26 in the network (block 90). Publishing the security policy document to the computer systems 26 involves transmitting the technical controls, data values or parameters in machine-readable form to implement the security policy on the computer systems 26. In a preferred embodiment, the technical controls are communicated from the policy management program 42 to the security management program 32.

The security administrator then uses the security management program 32 to verify a degree of compliance with the security policies demonstrated by the computer systems 26 (block 92). The security management program 32 enables the administrator to set or audit the parameters on the computer systems 26 (block 94). The administrator may run a checkup report to measure or change the parameters on the computer systems 26 (block 96). Additionally, the administrator may set the parameters on the computer systems 26 in response to the measurement to make the systems compliant with the policy. Additionally, detect rules may be configured when creating the security policy document and may be communicated to the computer systems 26, instructing the agent software 28 on the computer systems 26 to notify the security management program 32 of any future changes in configuration of the security parameters on the systems (block 98).

A typical security administrator may use the disclosed software in the order presented in the above steps, but this is not necessary. Additionally, the security administrator may repeat these steps whenever the security policy needs to be updated, which may be performed several times a year in modem computing environments.

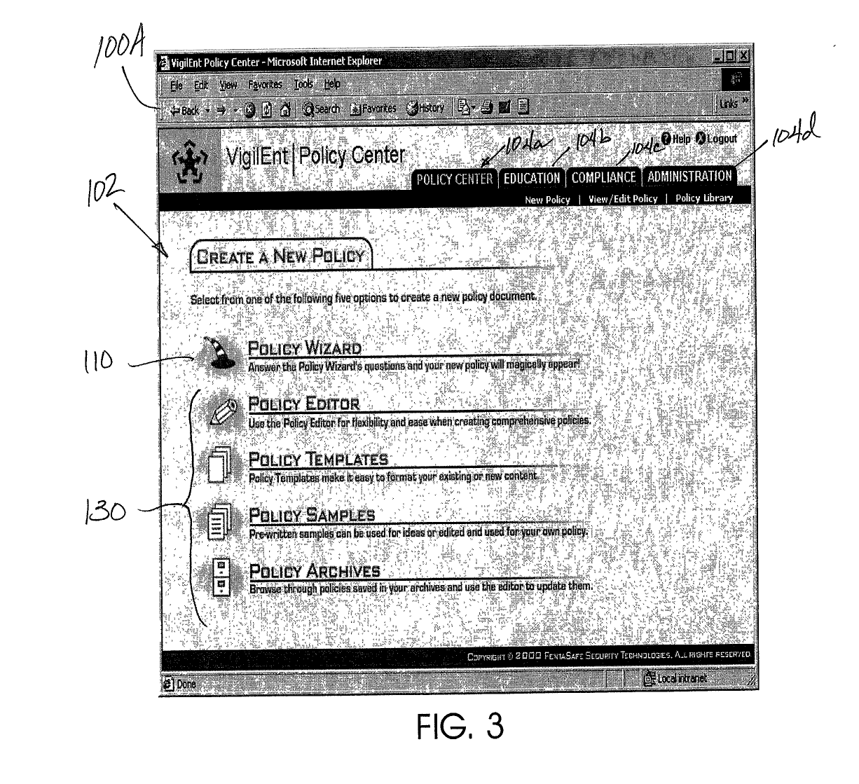

In FIGS. 3-11 that follow, the disclosed software will be explained with reference to a commercial embodiment of the policy management program 42 as embodied in a commercially available product called the “VigilEnt Policy Center.” Aspects of the policy management program 42 are presented using a series of exemplary screens and interfaces to illustrate the method employed. As one skilled in the art will readily recognize, this software is written to be compliant with the Windows 95/NT/2000 operating system. Information is displayed in a manner similar to the familiar Windows Explorer program that comes with those operating systems. Additionally, the program can be written in the Java programming language, which would allow the program to operate on most commercially available systems, including Unix-based or perhaps even Macintosh-based computers.

Referring to FIG. 3, an exemplary screen 100A of the policy management program is illustrated having a menu interface 102. From this menu interface 102, the security administrator may initiate and perform the steps described above. The menu interface includes a Policy Center Folder 104a for drafting and editing security policy documents, an Education folder 104b for drafting and editing quizzes, a Compliance folder 104c for reviewing user compliance, and an Administrative Folder 104d for organizing and controlling the policy management program.

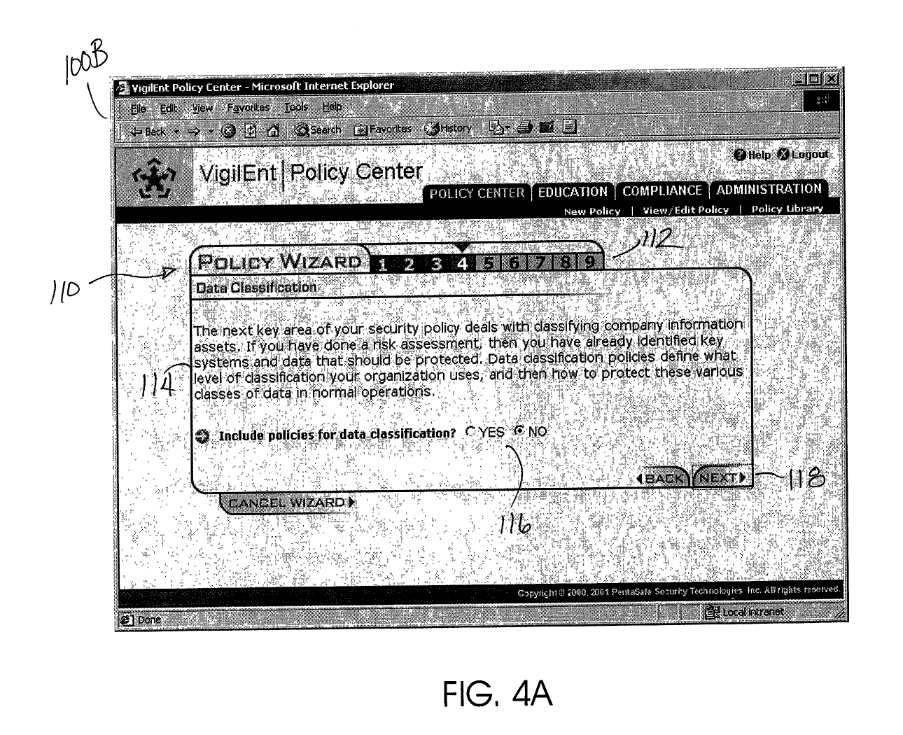

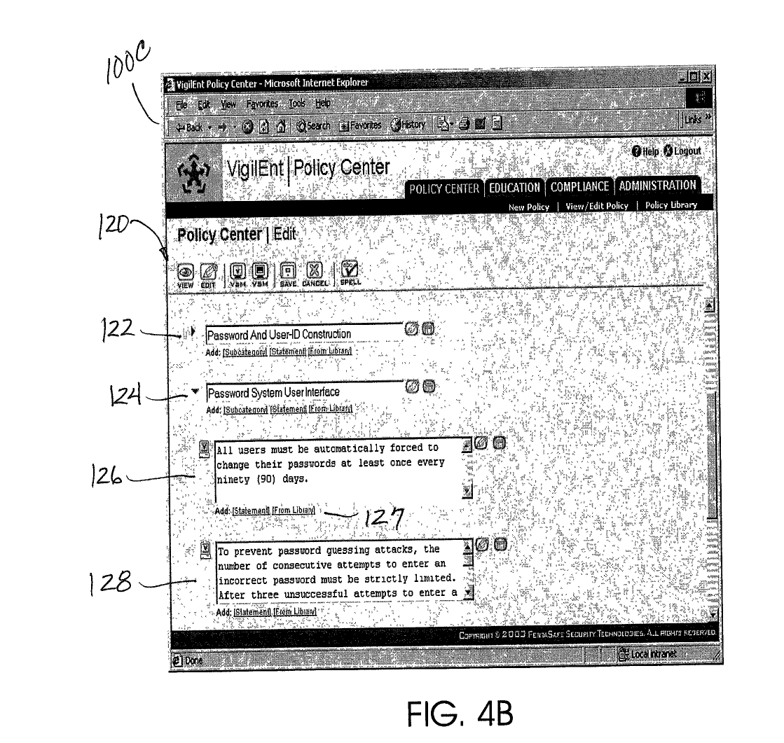

Currently, the Policy Center folder 104a is selected. The policy management program facilitates the creation of security policy documents by providing the security administrator with several options for creating security policies. In one option, the administrator may use a Policy Wizard 110 to create a new security policy. The Policy Wizard 110, which is discussed in more detail with reference to FIGS. 4A-B, uses a set of security categories and a library of security policies to facilitate the administrator in creating a suitable set of security policies for their network. In other options 130, the administrator may create a security policy document by editing or copying policies, templates or samples stored in the system or provided with the disclosed software.

Referring to FIG. 4A, an exemplary screen 100B of the policy management program is illustrated for the Policy Wizard 110. The Policy Wizard 110 allows an administrator, especially one who is not skilled in the art of information security, to create security policy documents for their network by reviewing a series of Wizard screens. The series of Wizard screens systematically takes the administrator through the creation process and presents various options. In other words, using the Policy Wizard 110, the administrator selects a set of predefined security categories related to their particular computing environment. The Policy Wizard 110 then compiles a security policy document for the administrator from a library of stored security policies provided with the software. The Policy Wizard 110 compiles the guidelines used in educating the users on the security policies from the selected categories. Moreover, the Policy Wizard 110 compiles the technical standards used in implementing the security policies on the computer systems from the selected categories.

In FIG. 4A, the Policy Wizard 110 presents a series of predefined security categories 112 (nine are shown). Each security category 112 includes an explanation and example 114 discussing how the security category may apply to a particular network or computing environment. For example, a category 112 for data classification is presented in FIG. 4A and is the fourth category of the Policy Wizard 110. Besides data classification, the Policy Wizard may address other security categories, such as electronic mail security, virus protection, network access control, or physical security. After reviewing the explanation 114 and considering how the category 112 may apply to their particular needs, the security administrator is prompted to include or exclude the particular category 112 in creating a security policy document by a field 116.

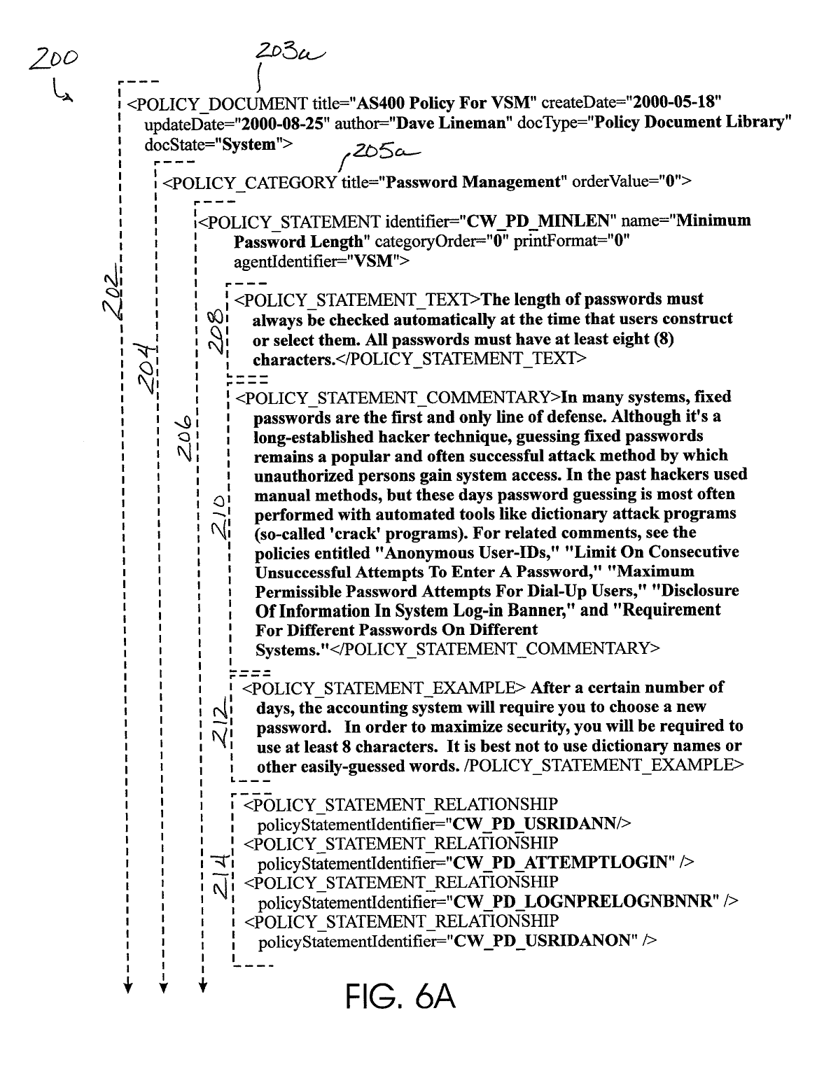

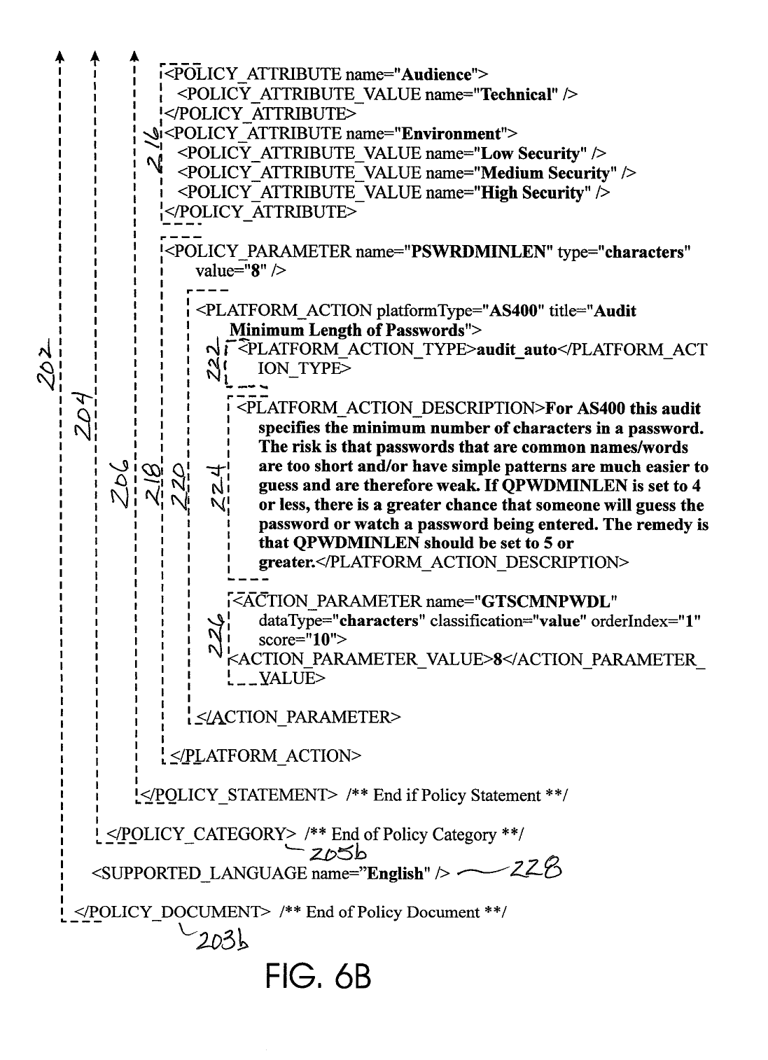

Based on the administrator's inclusion of the security categories as facilitated by the Policy Wizard 110, the policy management program automatically compiles an appropriate security policy document selected from a library of security policies distributed with the disclosed software. The automated features of the Policy Wizard 110 are possible due to the use of a structured data representation, which in a preferred embodiment is represented in an Extensible Markup Language format such as disclosed below with reference to FIGS. 6A-B.

Once the security policy document is created, the Policy Wizard 110 provides a summary of the security policy document to the administrator containing the selected policies from the Wizard. The security policy document thus enters a draft stage of the Policy Wizard 110. In the draft stage, the administrator may modify or edit the document to fit the needs of their particular network or computing environment, if necessary. To modify or edit the newly created security policy document, the administrator uses an editor. The editor may be provided in the Policy Center screen 110A once the administrator selects Next 118 from the last security category 112.

Referring to FIG. 4B, an exemplary screen 100C of the policy management program is illustrated having an editor 120. The editor 120 may form part of the Policy Wizard discussed above or may be accessed from the menu interface 102 of FIG. 3. The editor 120 allows the administrator to create and edit the security policy document in human-readable form communicable to the users. The editor 120 uses a plurality of text fields, which include, for example, fields for a category 122 for the policy, a sub-category 124 for the policy, a statement 126 of the policy, and a comment 128 on the policy. Other fields (not shown in FIG. 4B) may include examples of the policy, links to other related policies, and quiz questions that can be used to verify a user's understanding of the policy. Statements may be added and edited in the text fields to construct the security policy document. Statements may also be obtained from the library of stored policies using links 127. The editor 120 allows the administrator to add or delete text fields altogether. In addition, the security administrator may selectively organize or index the categories and sub-categories to create a structured hierarchy of security policies fitting their particular needs.

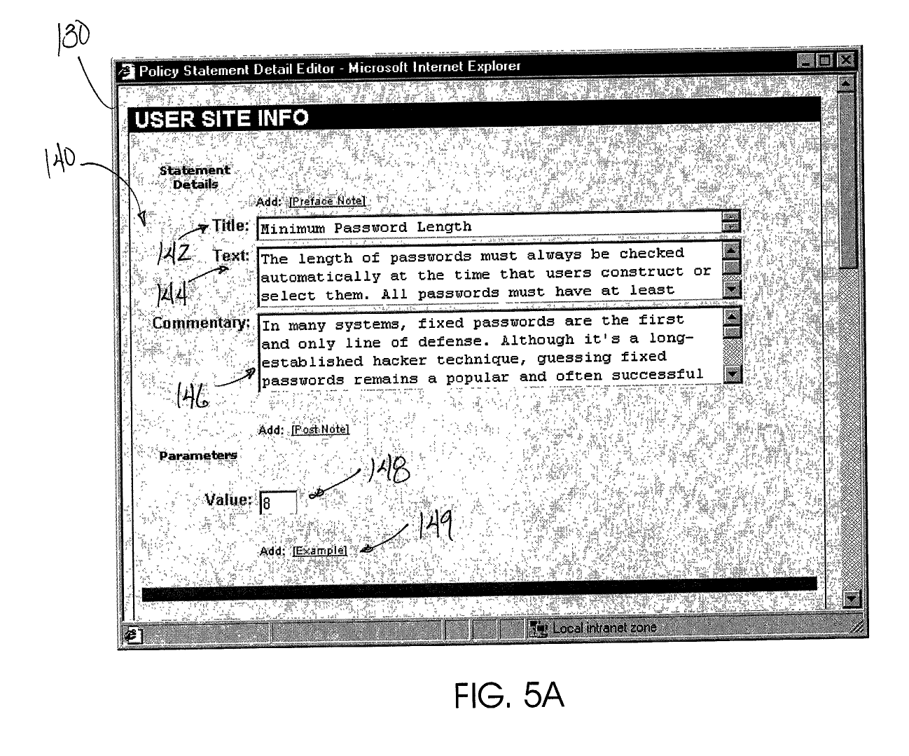

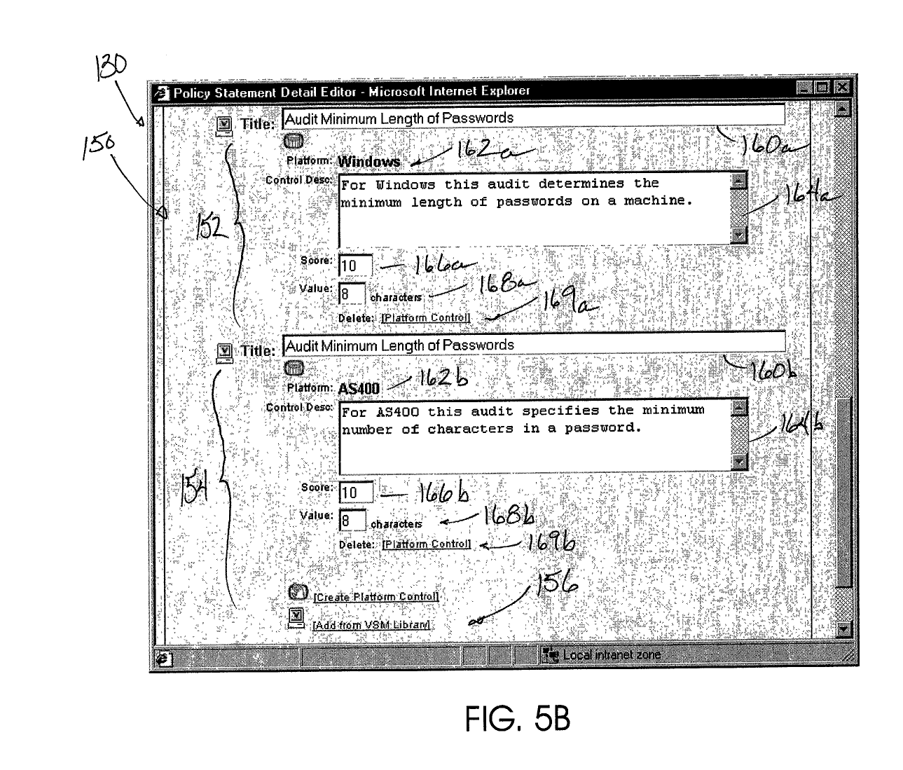

As noted above with reference to the menu interface 102 of the screen 110A in FIG. 3, the administrator may use the options 130 to create or edit a security policy document. Referring to FIGS. 5A-B, an exemplary detailed policy editor 130 is illustrated for the policy management program. Using the detailed policy editor 130, the administrator may review and edit the security policy information, as it will be provided to users on their computers 50 when distributed. As shown in FIG. 5A, an exemplary screen of the policy editor 130 depicts a portion 140 of the editor for modifying information 140 to be made available to the users in the network. The administrator may review and edit the title 142, text 144, commentary 146, and parameter 148 of the security policy document. The parameter 148 is the data value or technical control related to the security policy. Thus, parameter 148 for the “minimum password length” policy shown in FIG. 5A specifies that a minimum password length of “8” is required pursuant to the policy. Furthermore, the administrator may add an example 149 of the security policy described in the document.

In another aspect, the detailed policy editor 130′ allows the administrator to view and change the security policy document in the machine-readable form communicable to the computer systems. As shown in FIG. 5B, another exemplary screen of the policy editor 130 depicts a portion 150 of the editor for modifying the machine-readable form of the security policy document. Using the detailed policy editor 130′, the administrator is able to edit the technical and platform controls, which represent the translation of the written security policy language into a technical, machine-readable language. The technical controls are used to implement the security policies on the various computer systems of the network. The platform controls are used to implement the technical controls on the various platforms of the network.

Because the commands required to enforce the security policy document are different for each platform 20, 22, 24 in the network 10, a platform control is included in the security policy document for each type of computer system 26 represented in the computer network 10. If the policy document, for example, states that the minimum password length must be seven (7) characters long, then the procedures for setting and auditing this security policy is different for computer systems manufactured by IBM (AS/400), Sun Microsystems (Unix) and Microsoft (Windows NT). Therefore, the security policy document requires a platform control for each of these systems.

For example, platform controls for a Windows platform 152 and an AS400 platform 154 are shown in FIG. 5B. Each platform 152 and 154 includes a technical control title 160a-b, platform name 162a-b, description 164a-b, a score 166a-b and value 168a-b. The score 166 is a penalty for a machine or computer system when out of compliance with the technical control as described below. The value is the actual parameter of the technical control to be implemented on the various systems of the particular platform. Using links 156 on the interface 150, the administrator may create technical and platform controls or add controls from a library of stored platform controls. The administrator may also delete a platform control with deletion fields 169a-b.

As the administrator creates and edits the security policy document, the policy management program internally makes changes to a structured data representation of the security policy document. For example, if the administrator adds a platform control to the security policy document using the policy editor 130, the policy management program inserts a corresponding computer code or statement into the appropriate location of the structured data representation of the security policy document. Once the security policy document is complete, the administrator saves the security policy document. The policy management program then stores the security policy document in an embedded database of the data service engine 60, where the text fields, statements, platform controls and technical controls are organized in data tables.

As discussed earlier, the structured data representation of the security policy document is used to communicate the security policy to the users 54 and the computers systems 26. As also noted earlier, the policy management program 42 advantageously represents the security policy document in both human-readable and machine-readable form. In a preferred embodiment, the security policy document is represented using a structured data representation technique known as Extensible Markup Language (XML). However, other markup languages, such as Standard Generalized Markup Language (SGML), object languages, such as Unified Modeling Language (UML), computing languages, such as Java or JavaScript, or other portable representation languages may also be used.

Extensible Markup Language (XML) is known in the art for representing richly structured documents over the web and is, therefore, preferable for representing the security policy documents of the disclosed software. Furthermore, XML does not specify any semantics or tag set to be used in representing the documents, which is suitable for the innovative methods of creating and publishing the security policy documents as described herein.

Referring to FIGS. 6A and 6B, an exemplary XML file 200 of a security policy document is illustrated in accordance with the disclosed software. Within the XML file 200, certain data elements are identified by tags beginning with <TAGNAME attribute=value> and ending with </TAGNAME>. The information of the data elements is contained between these beginning and ending tags. For example, the policy document's title (AS400 Policy for VSM), creation date (2000-05-18) and author (Dave Lineman) 202 are identified by the <POLICY_DOCUMENT> tags 203a-b.

The <POLICY_DOCUMENT> data element 202 includes data elements 204-216 for communicating the security policy document to users in the network. In addition, the <POLICY_DOCUMENT>data element 202 includes data elements 218-226 for implementing the security policy on computer systems in the network. The data elements identified by the tags may themselves include tags containing further embedded data elements. For example, within the <POLICY_DOCUMENT> tags 203a-b, the <POLICY_CATEGORY> data elements 204 are identified by the <POLICY_CATEGORY> tags 205a-b. The <POLICY_CATEGORY> data element 204 is used to create a hierarchy of statements that represent different areas or categories of information security, for example, password construction, login procedures, etc.

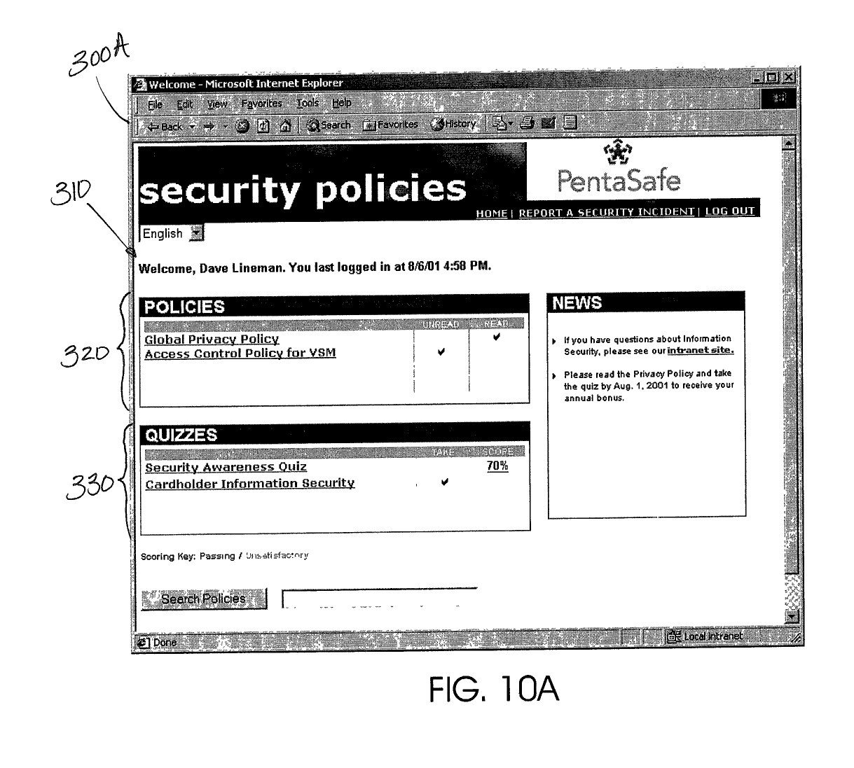

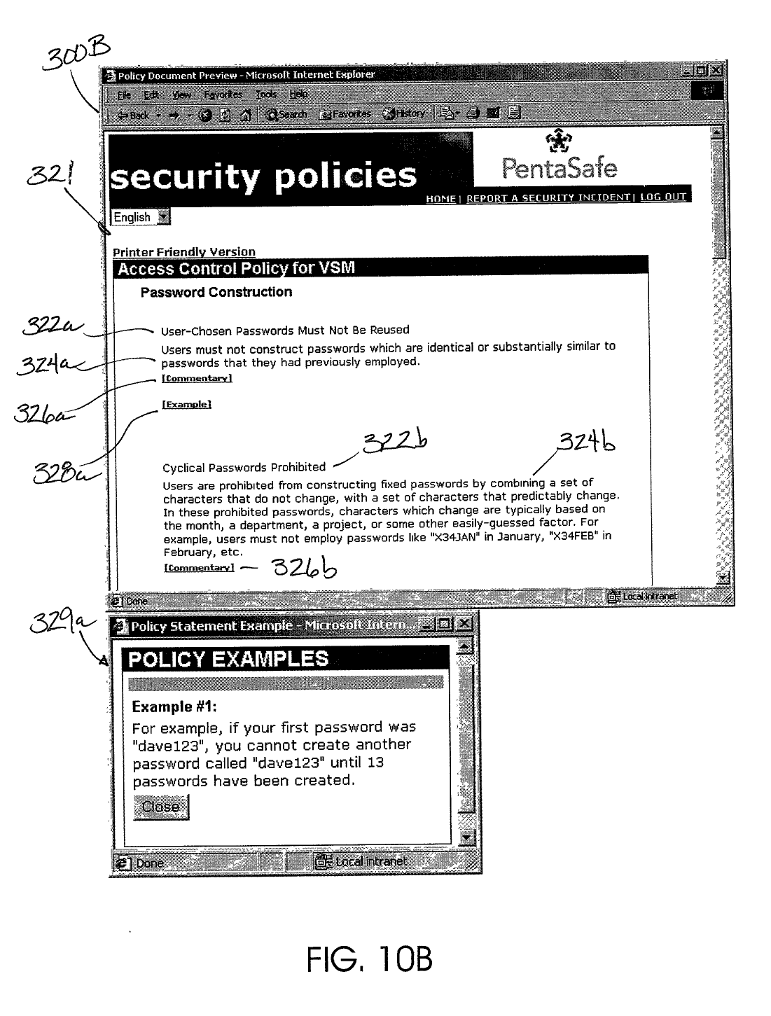

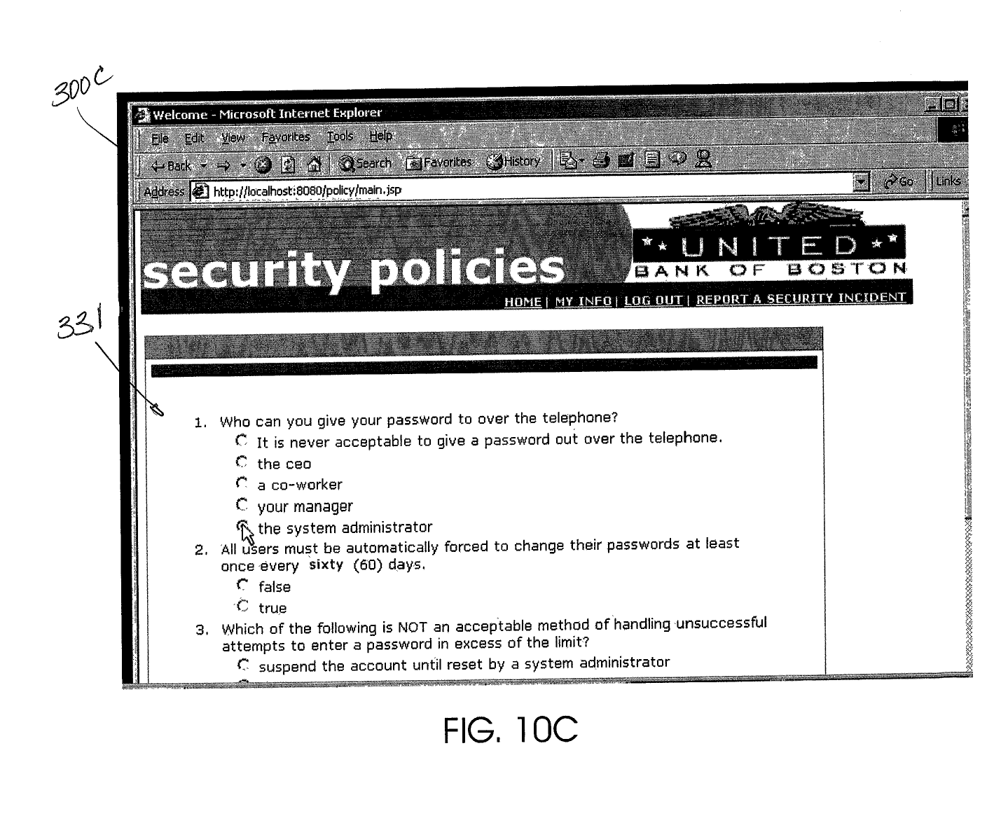

As noted above, the <POLICY DOCUMENT> data element 202 includes data elements 204-216 for communicating the security policy document to users in the network. For example, the <POLICY_STATEMENT_TEXT> 206 provides a statement of the security policy in human-readable form and corresponds to text entered in the text field 144 of the policy editor 130 as shown in FIG. 5A. When the XML file 200 is interpreted by the software program for access by the users, this data element 206 is provided for viewing by the user. (FIG. 10B shows how this security policy document would be presented to a user accessing the policy server 40 with the Web Browser program 52.)

The <POLICY_STATEMENT_COMMENTARY> 208 provides additional description or explanation of the security policy in human-readable form and corresponds to text entered in the commentary field 146 of the policy editor 130 in FIG. 5A. The <POLICY_STATEMENT_EXAMPLE> data element 210 provides a set of real-life examples of when the security policy should be applied. The <POLICY_STATEMENT_EXAMPLE> data element 210 would correspond to an example entered under the link 149 in FIG. 5A. When the XML file 200 is interpreted for access by the users, these related data elements 208 and 210 are provided as links within the security policy document (see links 326 and 328 in FIG. 10B).

Other data elements useful in communicating the security policy document to the users include a <POLICY_STATEMENT_RELATIONSHIP> data element 214 and a <SUPPORTED_LANGUAGE> data element 228. The <POLICY_STATEMENT_RELATIONSHIP> data element 214 defines relationships between the present security policy with other security policies covered by other related security policy documents. The <SUPPORTED_LANGUAGE> data element 228 enables the security policy data to be represented in a number of languages.

As noted above, the <POLICY_DOCUMENT> data element 202 includes data elements 218-226 for implementing the security policy on computer systems in the network. The <POLICY_PARAMETER> data element 218 contains most of the platform controls that link the written security policy to the mechanism for communicating the security policy to the computer systems 26 on the various platforms 20, 22, 24 of the network 10. The <POLICY_PARAMETER> data element 218 also contains most of the technical controls that link the written security policy to the mechanism for enforcing the security policy on the computer systems 26 in the network 10.

In order to set or audit data values or parameters on a specific computing platform, the XML file 200 includes a <PLATFORM_ACTION> data element 220. This data element 220 includes the platform controls that link the parameter of the technical control in the <POLICY_PARAMETER> 218 with the necessary representation to set or audit this parameter on a specific computing platform, for example, the IBM AS400. In the present example, the security policy relates to the securing policy, “Minimum Password Length.” Accordingly, the parameter value may be set to “eight” and the parameter unit may be set to “characters” for the minimum password length. In another example, the security policy may refer to accounts being disabled after “60” days of inactivity. The parameter value in this case may be set to “60” and the parameter unit may be set to “days”.

When the administrator edits or creates the technical and platform controls of a security policy document using either the Policy Wizard 110 or policy editors 130 as described in FIGS. 4 through 5, the policy management program automatically configures the appropriate data elements, such as 220-226. The policy management program 42 automatically modifies or inserts the data element into an appropriate location of the <PLATFORM_ACTION> data element 218.

As noted above with reference to FIG. 2, the disclosed software enables the security administrator to verify each user's access and comprehension of the security policy document. Distributing documents to users 54 via the network 10 is common in the prior art. It has been difficult, however, in prior art systems to determine which users 54 have read the documents and more importantly to determine which users 54 may actually demonstrate some understanding of the information. The policy management program 42 overcomes these shortcomings by enabling the security administrator to create a quiz that is administered to the user in conjunction with the security policy document. The quiz is used to test the user's knowledge and understanding of the content in the security policy documents that they receive.

For example, a company's security policy may require that users report security incidents (such as a virus or an observed infraction by a co-worker) through a specified channel. A quiz may then created to test the user's knowledge of this security policy and may be distributed to the users in conjunction with the security policy document. After reviewing the explanations, commentary and examples, the user accesses the quiz associated with the security policy document. The quiz presents the user with several options to identify the correct procedure related to this security policy. Each quiz answer may be weighted appropriate to the importance of the question, and a total score may be computed for each user on the quiz. In this way, the security administrator may measure the user's understanding of the security policy by reviewing their scores for the various quizzes.

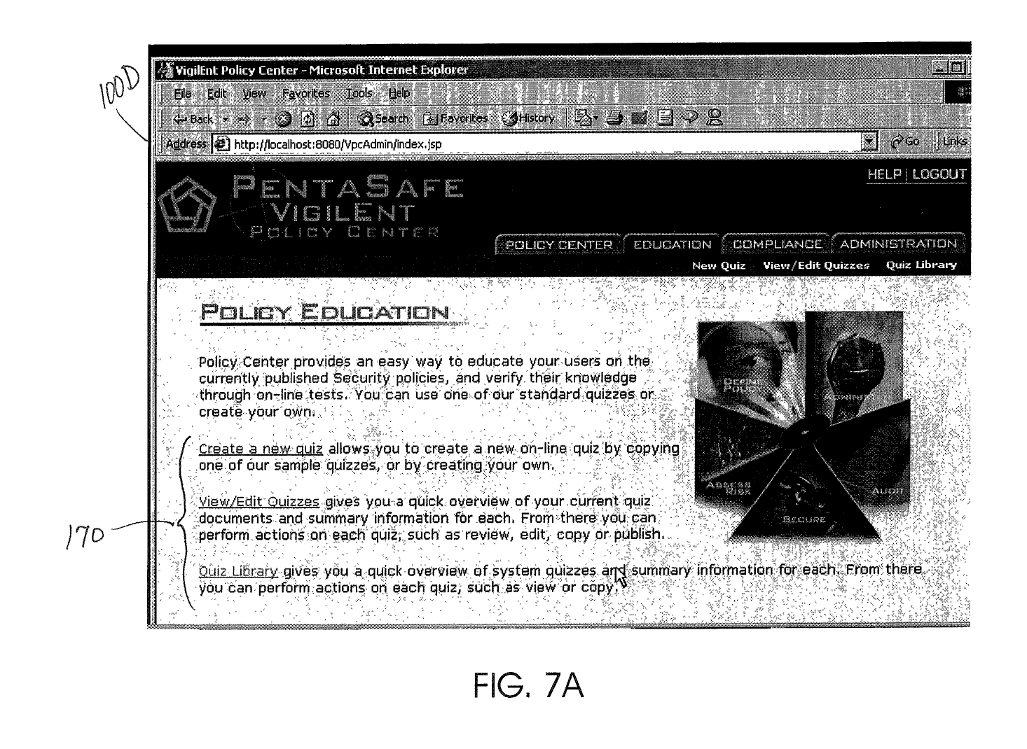

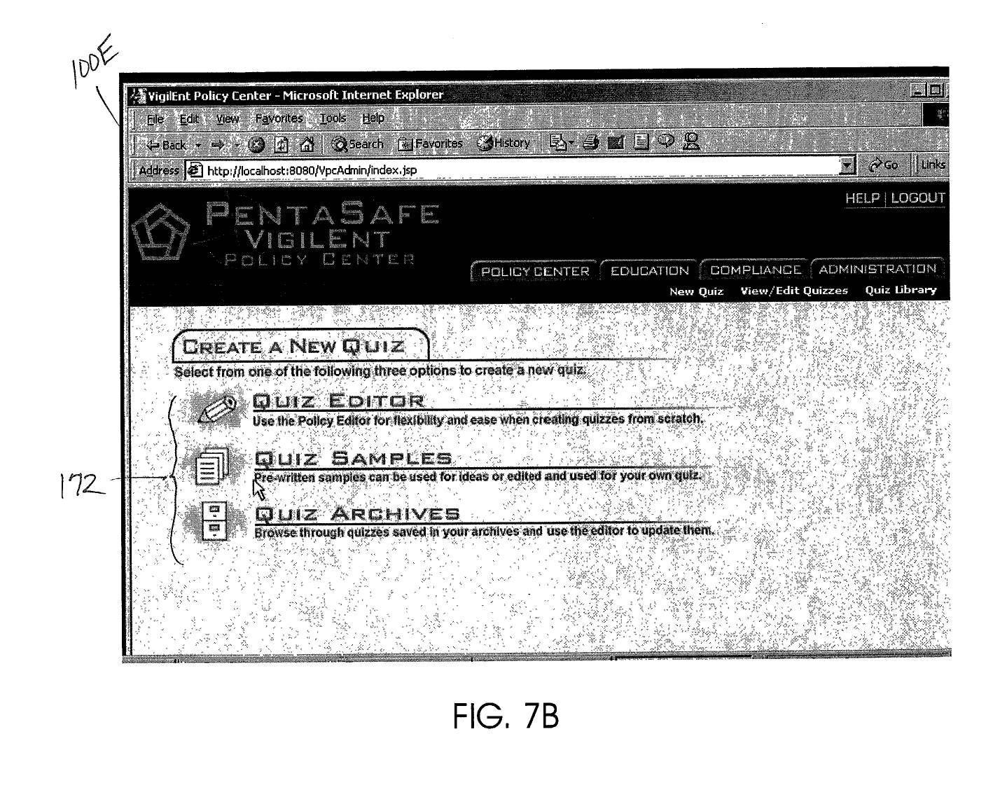

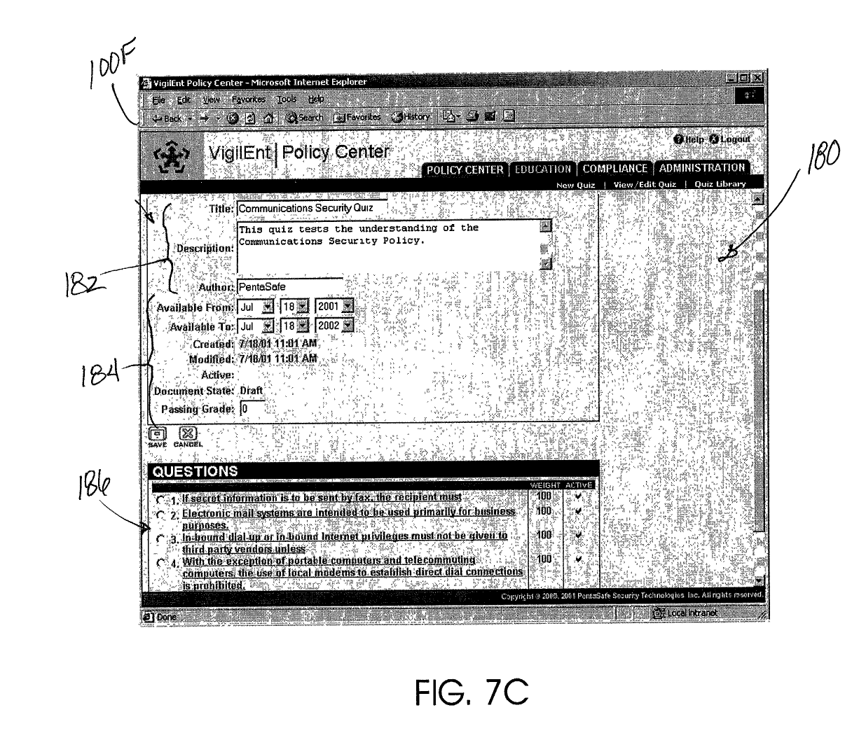

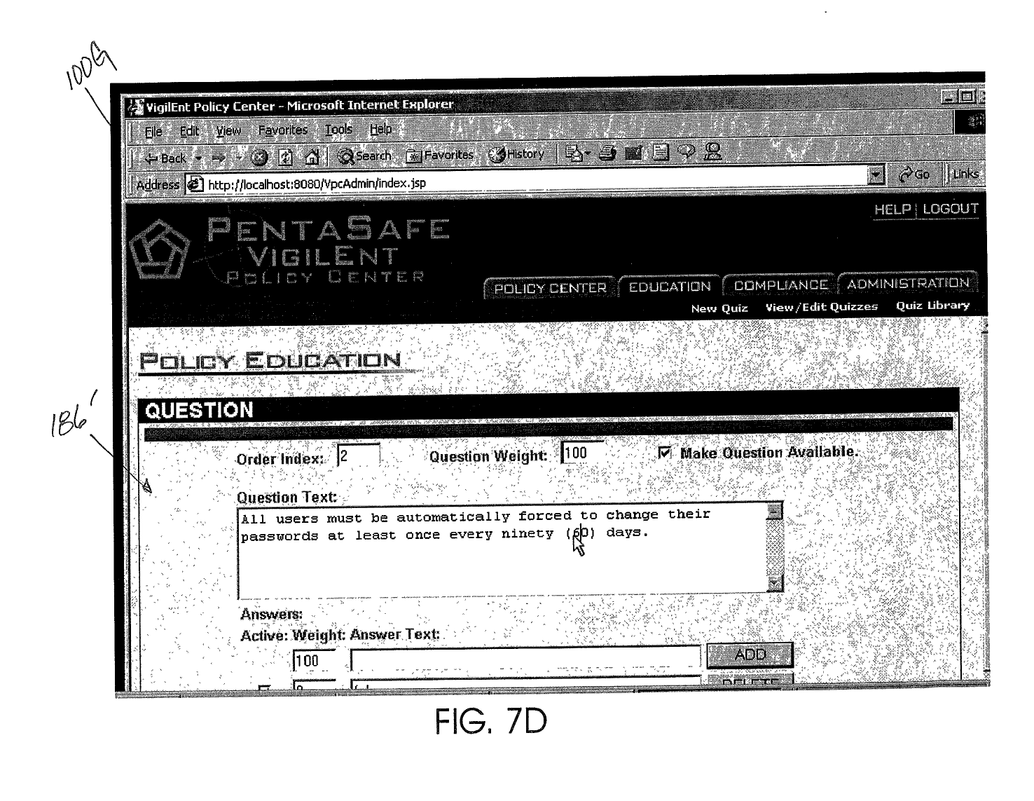

Referring to FIG. 7A, an exemplary screen 100D of the policy management program 42 is illustrated having an education menu 170. The education menu 170 includes options for creating a new quiz, for viewing/editing existing quizzes, or for copying quizzes from a library. By selecting, for example, the option of creating a new quiz, the administrator is provided with a quiz creation menu 172 as shown in the exemplary screen 100E of FIG. 7B. From the quiz creation menu 172, the administrator may select from options to create/edit a new quiz from scratch, copy/edit a quiz from samples, or review/update a quiz in an archive.

In selecting an option from the quiz menu 172, the administrator is provided with a policy quiz editor 180 as shown in an exemplary screen 100F of FIG. 7C. The policy quiz editor 180 provides title and description fields 182 that may be pre-populated and later modified by the administrator. In other fields 184, the administrator may specify the dates for which the quiz may be accessible to the users and may specify the minimum passing grade for the quiz. The policy quiz editor 180 also provides a list of questions 186 associated with the security policy document. Using the quiz editor 180, the administrator may inactivate particular questions. Furthermore, by selecting a question, the administrator may add/modify the questions or alter the weighting of the questions depending on the particular needs of the computing environment. For example, a question editing interface 186′ is illustrated in an exemplary screen 100G of the quiz editor 180, as shown in FIG. 7D.

In an embodiment of the policy management program 42, the Policy Wizard 110 referred to in FIGS. 4A-B may automatically construct quizzes matching the security policies in the security policy document when the administrator completes the creation process. The Policy Wizard 110 may compile sets of stored questions provided with the software in response to the options chosen in the Wizard 110. As with other aspects of the security policy document, the policy quiz editor 180 represents the quiz in an Extensible Markup Language (XML), although the XML commands for the quiz are not shown in the Figures for simplicity.

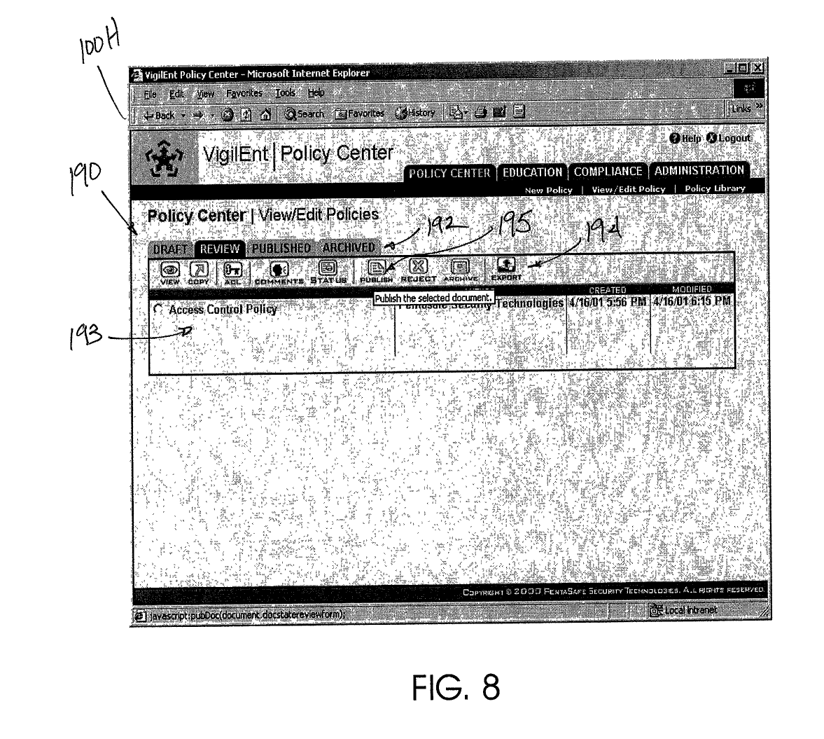

Once the security policy document has been created, the next step is to publish or electronically distribute the security policy document to the users 54 and computer systems 26 in the network 10. Referring to FIG. 8, an exemplary screen 100H of the policy management program is illustrated having a review interface 190. Included in a view/edit policy option and under a review folder 192, the review interface 190 shows a newly created security policy document called “Access Control Policy” 193 in a review stage. From the interface 190, the administrator may publish the security policy document by selecting a publish option 195 from a plurality of options 194. By publishing the security policy to the users 54, the administrator may verify the users' access and understanding of the security policy using the policy management program 42 on the policy server 40. By publishing the security policy document to the computer systems 26, the administrator may set or audit the security policy on the computer systems 26 using the security management program 32 on the security server 30. The security administrator may also establish detect rules for receiving notification when one or more of the computer systems 26 are out of compliance with the established policy.

Before documents are published, however, the administrator may put the security policy document through preparatory stages. In one stage, various people in the company responsible for approving security policy documents may view and make comments before publication of the document. During review, certain employees in the company are able to view the document 193 within their Web Browser and make comments relevant to the document. Using the policy management program 42, the administrator may then, for example, easily review these comments, reject the document or publish the document by selecting from options 194 on the review interface 190.

It is common in many companies that not all security policy documents should go to all users 54 in the network 10. For example, a laptop security policy may only apply to workers who routinely work on the road, such as sales people or executives. In another stage for preparing the security policy documents for publishing, an embodiment of the disclosed software allows the administrator to define which users are to have access to a particular security policy document once it is published. The ability to choose a selected group of users to receive a security policy document significantly enhances the communication of these security policies to the users. The users, in turn, only have to access and read those security policy documents relevant to their role in the company.

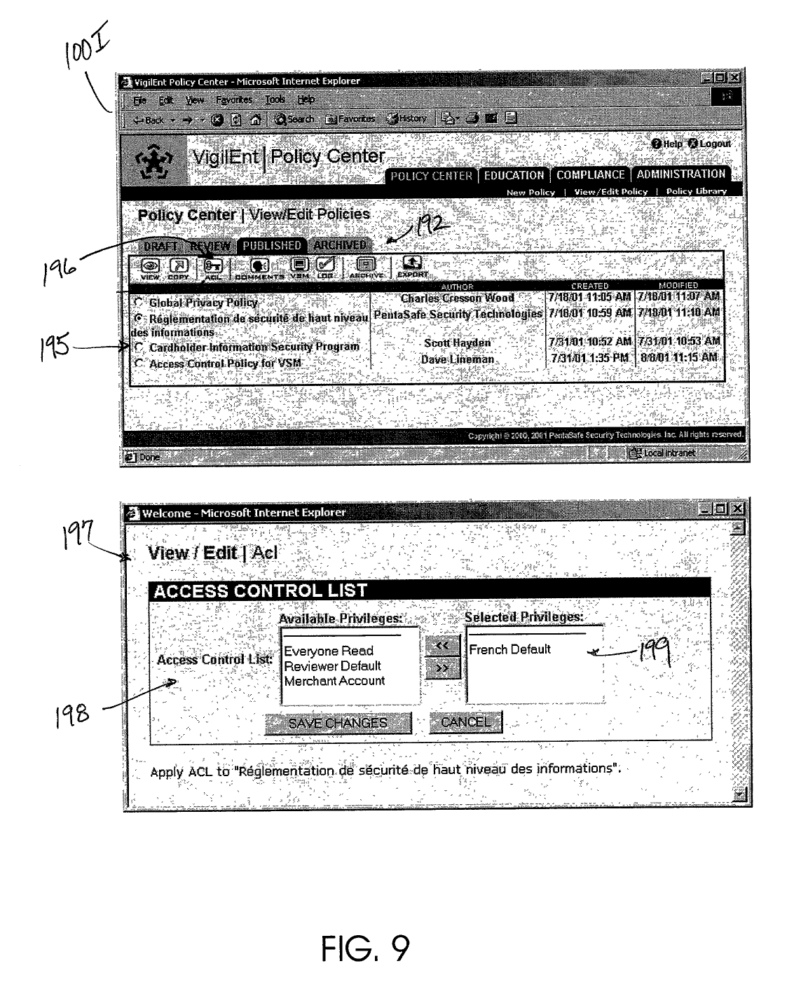

Referring to FIG. 9, exemplary screen 1001 of the policy management program is illustrated having a list 195 of published security policy documents. By selecting a security policy document in the list 195 and choosing an option 196, a window 197 is provided for limiting access to a security policy document based on a user's role in the organization. For example, only French-speaking users may be given access to a document in the list 195 written in French. French Default is listed in the selected privileges field 199 for the access control list 198. The administrator may apply the access control list to the selected document by saving the changes. The policy management program 32 further facilitates selecting a group of users by allowing the administrator to access their organization's existing user and group directories as already defined in their current computer network. Examples of such user and group directories include LDAP directories by IBM and Netscape/AOL or Windows Active Directory Services by Microsoft.

After these preparatory stages are performed, the security policy document is published using the publish option 195 in FIG. 8 of the policy management program 42. The security policy document becomes available for viewing by the selected group of users 54, who access a user web site on the policy server 40 using the Web Browser 52 loaded on the desktops 50. Referring to FIG. 10A, an exemplary screen 300A of a user web site is illustrated having a user menu 310. The user menu 310 presents a policy list 320 of security policy documents that the user is required to view and acknowledge. The user menu 310 also presents a quiz list 330 of the quizzes that the user must take.

To read a security policy document in the policy list 320, the user may click on the name, which is linked to the security policy document stored in the system. The security policy document is then rendered in a document interface 321 on a user web site screen 300B as illustrated in FIG. 10B. The security policy document includes one or more guidelines 322. Each guideline 322 includes an explanation 324 to instruct the user. The user may select a link to commentary 326 and receive additional detail of the security guideline. In addition, the user may select a link to an example 328 and receive examples of the guideline. For example, a policy statement example is rendered in window 329 of FIG. 10B.

Completing their review of the security policy document, the user may then verify that they have read the document by clicking a field (not shown) on the document interface 321. Thereafter, the user may be automatically presented necessary quiz questions or they may access the necessary quiz from the user menu 310 of FIG. 10A. Acknowledgement that the document was reviewed is then recorded within a database on the policy server 40. On the menu interface 310 of the user web site 300A, the reviewed documents and scored quizzes are updated to reflect the user's activities.

To take a quiz after reading the security policy document, the user may select a quiz in the quiz list 330 of FIG. 10A, if not automatically provided the quiz after reading the security policy document. Referring to FIG. 10C, a quiz interface 331 on a user web site screen 300C is illustrated. The quiz includes a number of multiple choice questions to assess the user's awareness and understanding of the security policy. After answering the questions, the user selects a field (not shown) on the quiz interface 331. The quiz is graded, and the user is provided with a graded version of the quiz on the screen 300C (not shown if FIG. 10C). The quiz results are recorded within a database on the policy server 40. On the menu interface 310 of the user web site 300A, the scored quizzes are updated to reflect the user's activities.

It is common in the prior art to simply distribute a document to users through a web site and not verify that the users have read the document by a specified date. Having a record of when a user electronically acknowledges reading a security policy may later become important if the user is disciplined for a policy violation. For example, a company may discipline an employee for abusing policies related to the use of e-mail. To support their action against the employee, the company may need verifiable facts of the date the employee read and understood the e-mail policy.

In a preferred embodiment, the policy management program records the exact date and time the user electronically acknowledges reviewing the policy document and takes the quiz. This data is recorded in a logged file, which uses a mathematical algorithm to match the contents of the logged file with the recording of the user review and quiz data. Thus, the policy management program may mathematically verify that the reading of a particular policy document took place at a specific date and time, assuming the computer clock was correct. The data may provide evidence in case the user later argues that he or she never read nor understood the security policy document when their violation of the security policy occurred.

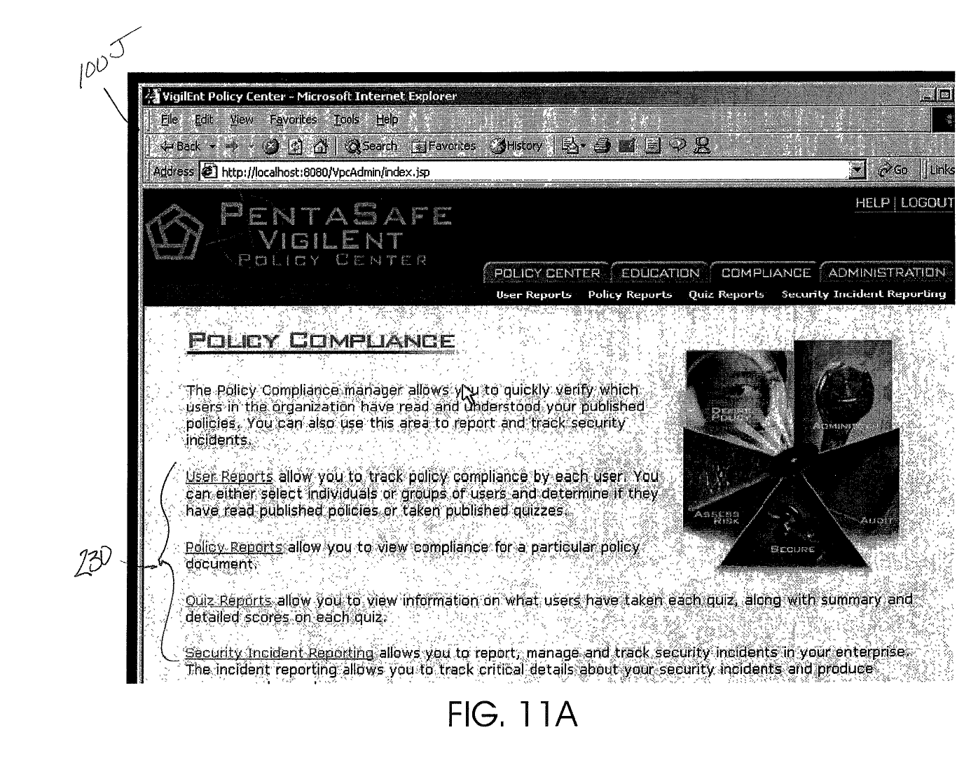

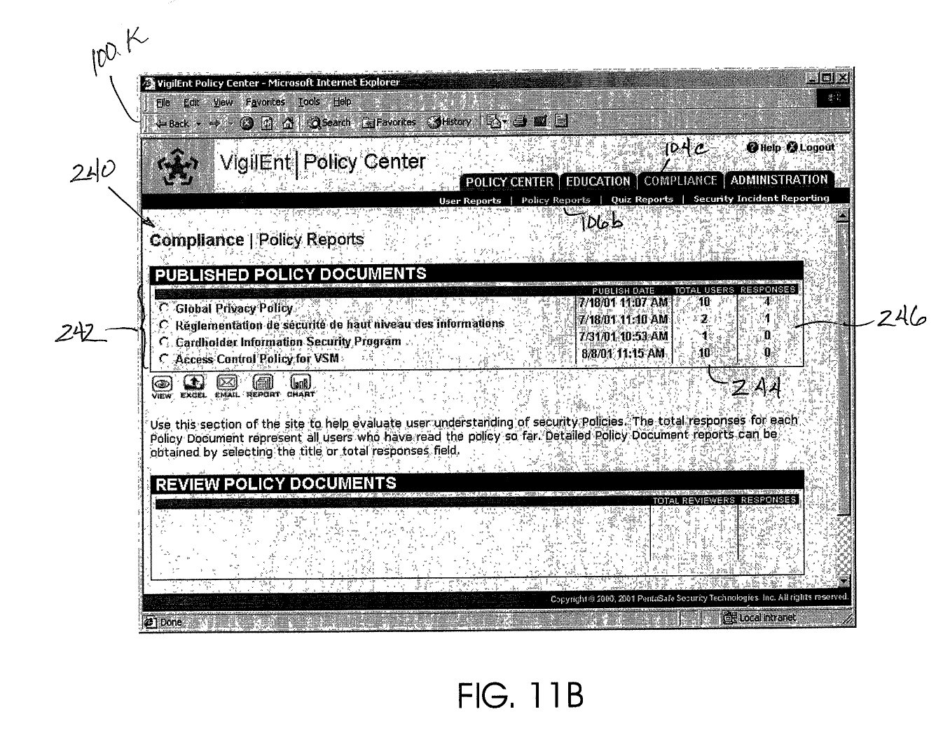

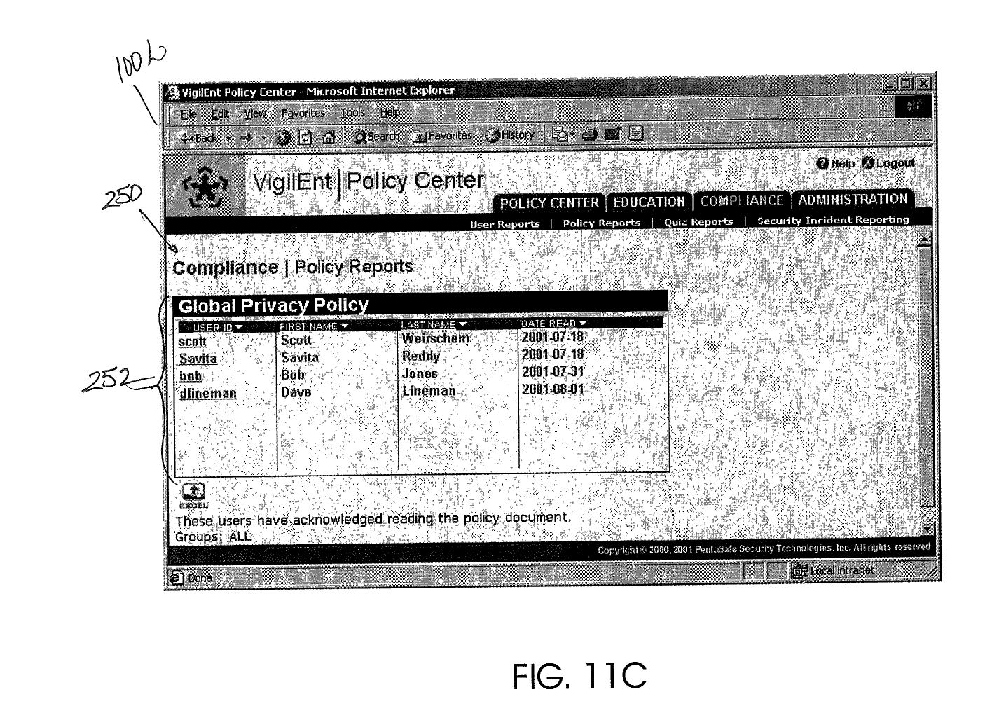

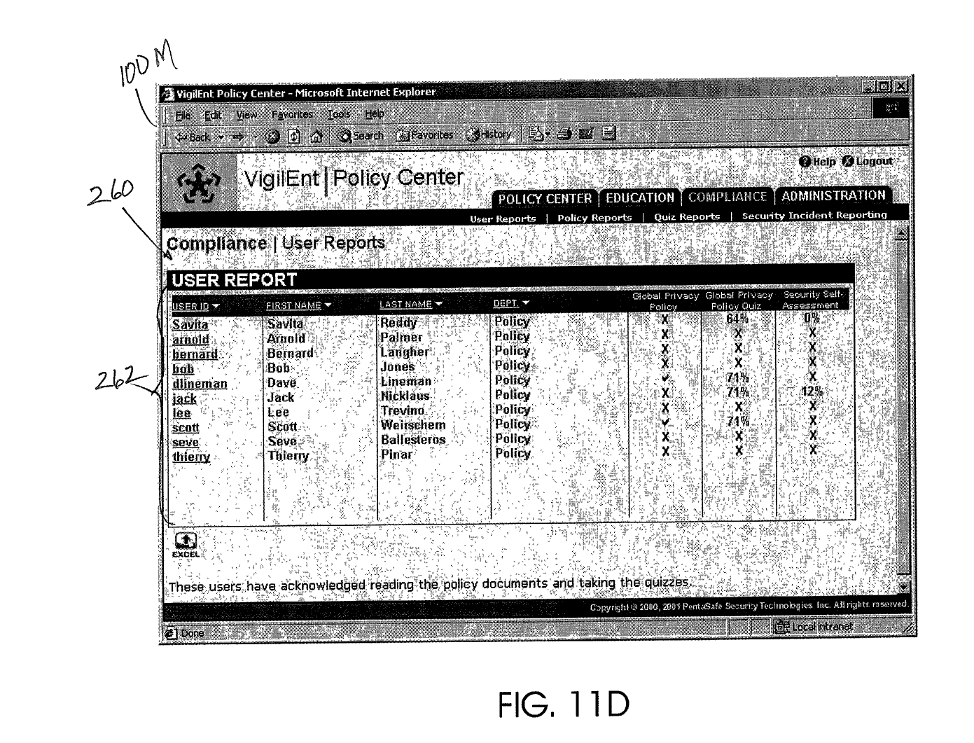

As noted previously, once the security policy document has been published to the users 54, the security administrator can verify user compliance with the security policy from within the policy management program 42. Referring to FIG. 11A, an exemplary screen 100J of the policy management program 42 is illustrated having a policy compliance menu 230. The administrator may review user compliance with the security policies by selection from a number of reports. The reports include user reports for tracking policy compliance for each individual user. Other reports include policy reports allowing the administrator to review user compliance with a particular security policy document. Yet other reports include security incident reports allowing the administrator to track and manage security incidents. One feature of the policy management program allows users to submit security incidents to the policy management program 42 from the user web site. These security incidents may then be managed and tracked by the administrator.

Referring to FIG. 11B, an exemplary screen 100K of the policy management program 42 is illustrated for a policy compliance report 240. The report 240 includes a list 242 showing a total number 244 of users required to access each published policy document and showing a number of responses 246 or users having accessed each document. As mentioned earlier, each time a user acknowledges reading a security policy document or verifies completion of a quiz, the policy management program 42 records the data on the policy server 40 and in logged files that can be checked for data integrity by the aforementioned method.

By selecting a security policy document from the policy compliance report 240, the administrator may view additional information concerning the compliance of the users. Referring to FIG. 11C, an exemplary screen 100L is illustrated for a user compliance report 250 for the “Global Privacy Policy” document illustrated in FIG. 11B. The user compliance report 250 provides a detailed list 252 of the individual users required to read the selected security policy document. Furthermore, the user compliance report 250 provides the dates when the user acknowledges reading and understanding the selected security policy document.

The administrator may obtain further detail concerning compliance of the users reviewing data for individual users or groups of users. Referring to FIG. 11D, an exemplary screen 100M illustrates another user compliance report 260. This user compliance report 260 shows a list 262 of all of the policies and quizzes required for each user and their level of completion. When quiz data is shown, the administrator can view the detailed quiz data for each user by selecting the user's name from the screen.

Additional reports may be beneficial in determining user compliance with the published security policy documents. For example, the administrator may generate a report showing, in aggregate, how each question of a particular quiz has been answered by users. Such a report may point out weakness in security to be addressed or may indicate a misleading quiz question. In addition, the administrator may review a graded quiz for a particular user.

In combination with or independent from publishing the security policy document to the users 54, the disclosed software publishes the security policy document to the security server 30 having the security management program 32. As previously noted, the security management program 32 is used to set and audit the security policies of the document on the various computer systems 26 of the platforms 20, 22, 24. Additionally, the security management program 32 is used to review detect rules, which are automatically created to enforce the policy of the platforms 20, 22, 24. In publishing the security policy document to the security management program 32, the policy management program 42 extracts the technical and platform controls from the XML file representing the security policy in the machine-readable form. The technical and platform controls populate the databases, files, and routines associated with the security management program 32. Using the technical and platform controls, the security administrator may verify compliance of the computer systems 26 and set/audit the systems from within the security management program 32.

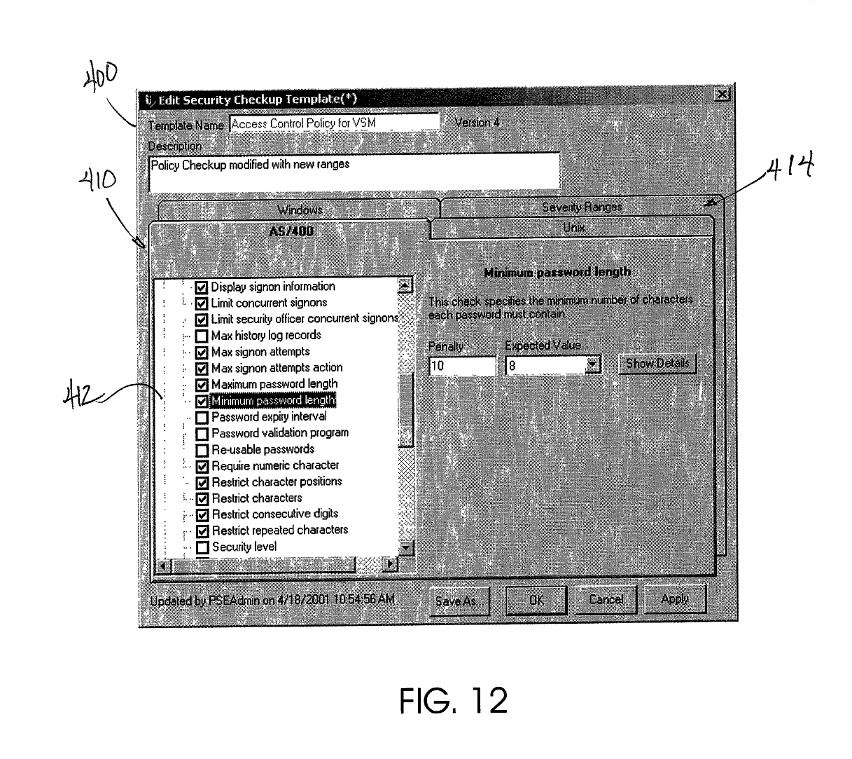

FIGS. 12-14 illustrate various aspects of the security management program 32. Referring to FIG. 12, an exemplary screen 400 of an Edit Security Checkup Template 410 illustrates technical and platform controls communicated to the security management program 32 from the policy management program 42. The Edit Security Checkup Template 410 is used to identify the technical and platform controls for generating compliance reports on computer systems in the network. The Edit Security Checkup Template 410 shows policy parameters 412 related to the technical controls for an “Access Control Policy for VSM”. The policy parameters 412 for various platforms are contained in separate folders 414 for the various operating platforms in the network.

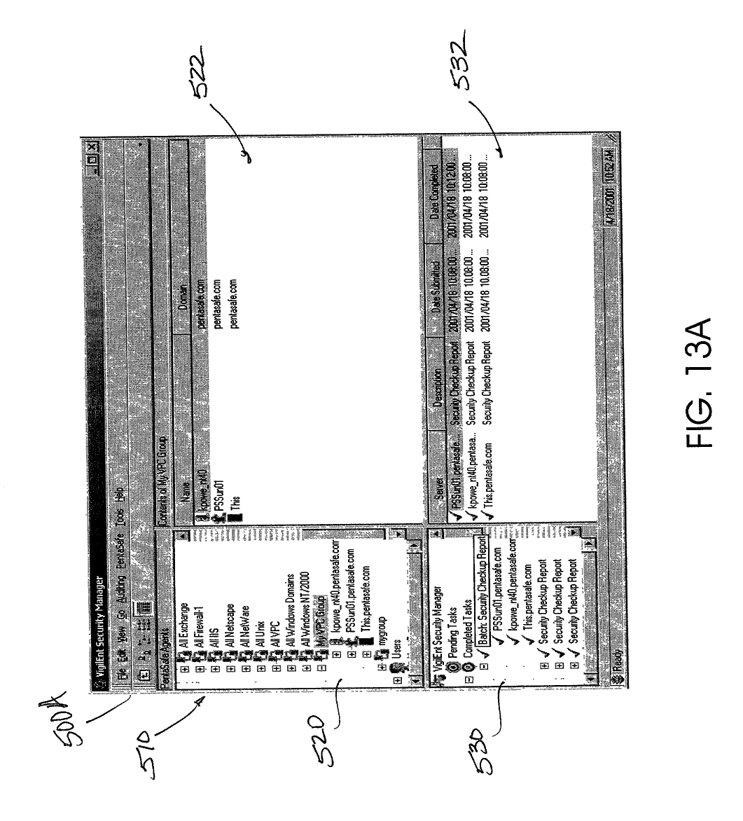

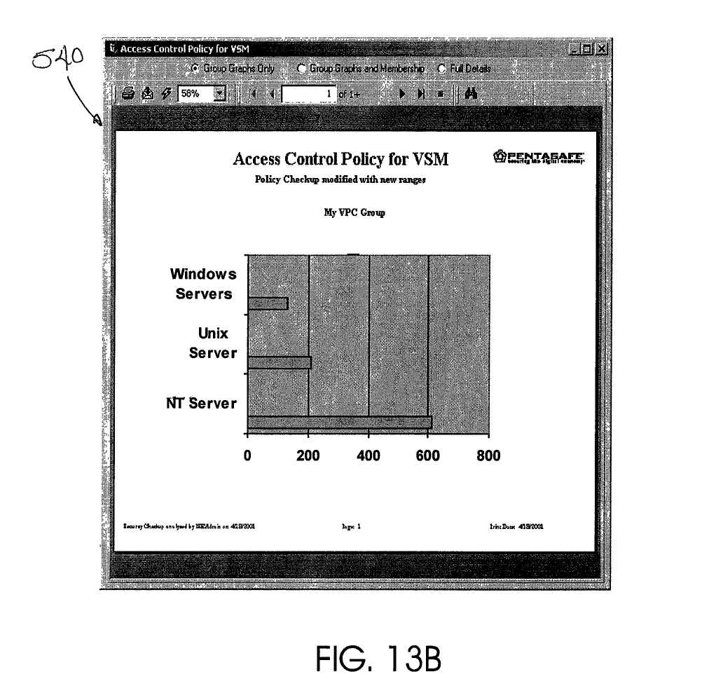

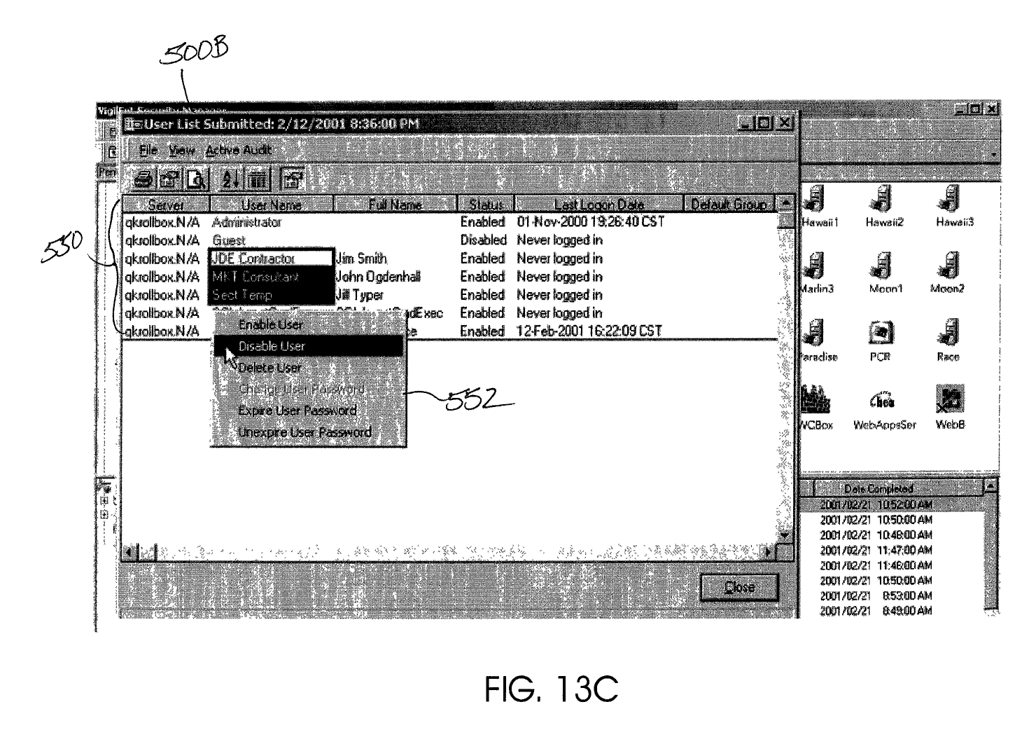

Once the parameters 412 have been identified for generating a compliance report with the Edit Security Checkup Template 400, the security administrator can run a policy checkup report against a selected group of computer systems 26 of the platform groups 20, 22, 24. Referring to FIG. 13A, an exemplary security manager screen 500A of the security management program 32 is illustrated. The security manager screen 500A shows a selected group of systems 520, detailed in 522, on which a policy checkup report 530, detailed in 532, has been run.

The policy checkup report 530 specifies the checks required to enforce each security policy. The security management program 32 may compute a total score or penalty representing the extent of compliance of any machine or group of machines in the network 10. The security management program 32 also allows the administrator to view the policy compliance report in a graphical format. Referring to FIG. 13B, a graphical summary 540 of the policy compliance report includes a bar graph showing the total score or penalty of the selected servers. For example, the Windows NT server has a total compliance score of 610. The total compliance score is computed by summing the scores (see FIG. 5B, elements 166a and 166b) for all policies for which the system is not in compliance. The higher the score the less the machine complies with the policy parameters tested in the policy checkup report. From these reports, the security administrator can obtain more detail about the machines' compliance with the security policy by clicking on the report. For example, the administrator could determine which policy checks failed for a given computer system.

After reviewing the compliance reports, the administrator may determine that some of the computer systems should be audited to comply with the parameters of the technical controls received from the policy management program 42. The security management program 32 enables the administrator to set and audit a machine to comply with the security policy from within its report. This is accomplished by sending commands from the security management program 32 to agent software 28 running on the various computer systems 26. This process can be repeated until the machines are at an acceptable level of compliance.

As noted earlier, the security management program 32 requires special software, known as the agent software 28, to be loaded on the various systems 26 in order to audit or set the policies on those systems. The desktop computers 50 are connected to servers of the various computer systems 26. Accordingly, the desktop computers 50 do not necessarily require agent software 28 to be loaded on them, as the servers will implement the security policies. The agent software 28 on the computer systems 26 responds to requests to measure, set or audit the security parameters and returns necessary data over the network 10 back to the security management program 32. The splitting of the software functions is beneficial and makes auditing easy to implement, but not strictly necessary.

The various computing platforms (e.g., 20, 22 and 24) usually require different commands to both collect data and make changes to the security data. For example, IBM, Microsoft, and Sun platforms are respectively built around the AS/400, Windows NT, and Unix operating systems, all of which require different commands to effectuate a similar security function. The tools provided by each platform vendor include a “command line” where the user types a command, a graphical interface for easy navigation with a mouse, or programming interfaces known as an API (Application Programming Interfaces) to allow programmatic changes. The steps followed to effectuate a given security function are generally similar between the different platforms, but the graphical layout and programmatic structure of the interface may not be identical.

To simplify this process, the disclosed software uses a metacommand language to allow the security management program 32 and the agent software 28 to communicate in a common language, regardless of the platform that the agent program is running on. In a sense, the agent software 28 acts as a translator between the metacommand language and the language understood by the operating system of the platform. Accordingly, the agent software 28, when installed on a particular system 26, is configured to operate with the operating system of that particular system 26. The metacommand language can perform common security tasks, actions, or requests for data that are conceptually similar across the various platforms, as well as platform-specific tasks. In addition, parameters accompany most metacommands to configure how the metacommand will be executed on the platform to which it is sent. Further explanation of metacommands may be found in U.S. patent application Ser. No. 09/520,304, filed Mar. 7, 2000 and entitled “Method and Apparatus for Actively Auditing Computers in a Network,” which is incorporated herein by reference in its entirety.

After running a report to discover the system compliance as shown in FIGS. 13A-B above, the administrator may determine that some of the selected systems should be corrected. Referring to FIG. 13C, an exemplary screen 500B of the security management program 32 is illustrated. To set/audit machines to comply with the parameters, the administrator selects computer systems from the report. (Three selected systems or “user names” are so selected in FIG. 13C.) The administrator then clicks on the selection with the right mouse button and selects an audit or set command from a shortcut menu 552. At this point, the security management program 32 internally transfers the list of computer systems to the processor within the core service engine 60. The processor formulates metacommands to effectuate the audit of the selected systems.

Once encoded, the processor sends the properly formatted metacommands to the relevant platform(s). At this point the agent software 28 decodes the metacommands and parameters into the operating system language for that platform and performs the desired function. After execution, the agent software 28 returns messages indicating success and any pertinent data to the security management program 32. Further explanation of auditing the various computer systems and platforms using the security management program 32 may be found in U.S. patent application Ser. No. 09/520,304.

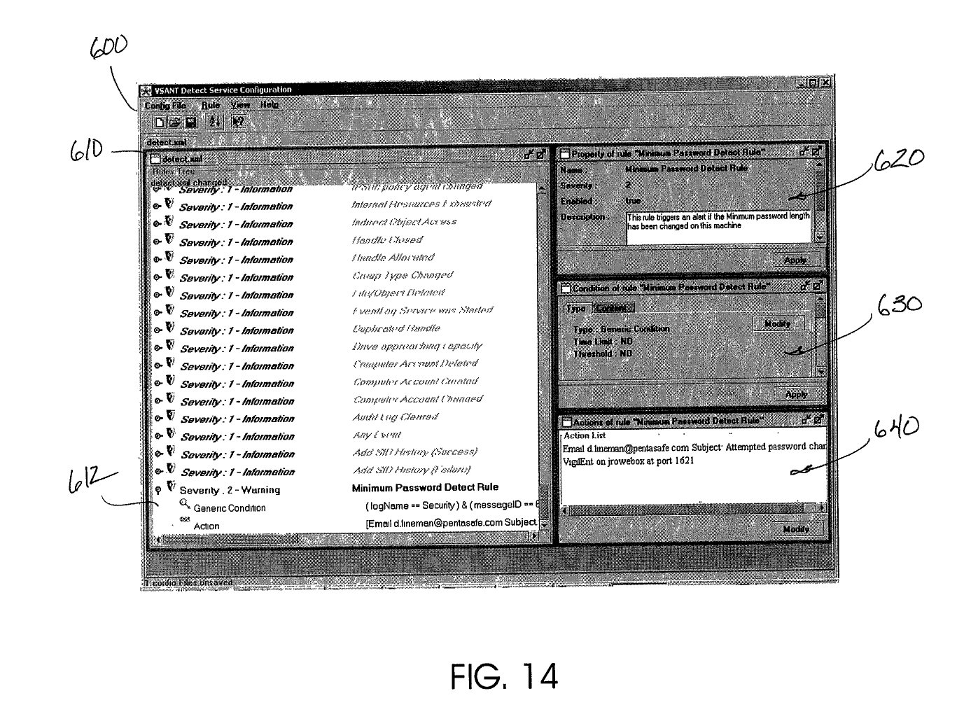

In another aspect of the security management program 32 as shown in FIG. 14, the security administrator can configure the system to automatically detect and report when a computer system 26 in the network 10 goes out of compliance with a defined security policy. In FIG. 14, a Detect Service Configuration screen 600 of the security management program 32 is illustrated. The Detect Service Configuration screen 600 includes an exemplary interface 610 showing alerts for detecting changes in security policies passed to the security management program 32 by the policy management program 42. When creating the security policy document with the policy management program 42 as described above, a set of detect rules may be automatically configured. The set of detect rules instructs the agent software 28 on the various platforms 20, 22, 24 to notify the administrator when important settings or parameters have been changed on the computer systems 26.

The interface 610 includes a rule tree 612 listing detect rules in a structured XML file named “detect.xml”. In a preferred embodiment of the security management program 32, the XML file is created with the security management program 32 using an editor with a visual interface and functionality similar to the policy editor described above with reference to FIGS. 5A-5B. The “detect.xml” file is not illustrated for simplicity. The detect rules in the XML file are used to detect any changes occurring on the computer systems 26. An example detection rule for “Minimum Password Detect Rule” is shown selected for further viewing, and its description 620 is provided on the screen 600 when detected. The conditions 630 of the detect rule are also provided and explain how the rule is categorized. Actions 640 of the detection rule are also provided. In this example, an alert email is sent via the network to a security administrator when the “minimum password length” detect rule is triggered by an altered setting or parameter on a computer system 26. Other possible actions may include instructions to the security management program 32 to execute a command to set the system or transmit a page or facsimile to a security administrator.

For example, a published security policy may require that the minimum length for new passwords be eight characters. This security policy is enforced by configuring settings on the various computer systems 26 in the network 10. If the configuration of one of the machines is altered so that the minimum password parameter is changed to seven characters, for example, the agent software 28 as instructed by the detect rules will notify the security management program 32 of the change. In turn, the security management program 32 will alert the security administrator immediately, using the actions 640 specified in the detect.xml. By reducing the time available for a security breach to occur due to a machine being out of compliance, the detect rules substantially reduce the security risk to the network 10.

By combing the compliance reports from the security management program 32 and the policy management program 42, a security administrator can obtain a comprehensive measure of the organization's compliance with their established security policies for both users 54 and computer systems 26 in the network 10.

From the foregoing detailed description of specific embodiments of the disclosed software, it should be apparent that an improved method for managing the security policies of an enterprise has been disclosed. Although specific embodiments of the invention have been disclosed herein in some detail, this has been done solely for the purposes of illustrating various aspects and features of the disclosed software, and is not intended to be limiting with respect to the scope of the invention.

It is contemplated that various substitutions, alterations, and/or modifications, including but not limited to those design alternatives which might have been specifically noted in this disclosure, may be made to the disclosed embodiments without departing from the spirit and scope of the disclosed software as defined in the appended claims. For example, the disclosed software can be used to distribute any type of policy document to users and track the results. In addition, the methods for linking the security policy document to various system controls can be used to manage and communicate the security policies to other computing devices.

From the foregoing detailed description of specific embodiments of the invention, it should be apparent that a system and associated methods for managing user and computer security on a network have been sufficiently disclosed in a manner to allow one skilled in the art to make and use the same. Although specific embodiments of the invention have been disclosed herein in some detail, this has been done solely for the purposes of illustrating various aspects and features of the invention, and is not intended to be limiting with respect to the scope of the invention. It is contemplated that various substitutions, alterations, and/or modifications, including but not limited to those design alternatives which might have been specifically noted in this disclosure, may be made to the disclosed embodiments without departing from the spirit and scope of the invention as defined in the appended claims. For additional details concerning the disclose software, the reader may wish to refer to the “VigilEnt Policy Center User Guide,” distributed by PentaSafe Security Technologies, Inc., Park Towers North, 1233 W. Loop South Suite 1800, Houston, Tex., 77027, which is hereby incorporated by reference in its entirety for all that it teaches.

What is claimed is:

1. A method for managing a security policy for one or more users in a network, comprising:
a) running a policy management program on a computer in communication with the network;
b) enabling creation of a security policy document using the policy management program;
c) enabling the one or more users on the network to view the security policy document; and
d) receiving electronic data relevant to user viewing of the security policy document using the policy management program.

2. The method of claim 1, further comprising verifying a degree of user compliance with the security policy by using the policy management program to assess the received data.

3. The method of claim 2, wherein the received data includes a timestamp denoting the time a user acknowledges viewing of the security policy document.

4. The method of claim 2, wherein the received data includes quiz results indicative of the user comprehension of the viewed security policy document.

5. The method of claim 1, wherein enabling the creation of the security policy document comprises enabling selection of security policies from a set of options.

6. The method of claim 5, wherein the security policies selected from the set of options reside in a library in communication with the policy management program.

7. The method of claim 1, wherein enabling the users on the network to view the security policy document comprises enabling pre-selection of a group of users to view the security policy document.

8. The method of claim 1, further comprising electronically providing a quiz to assess user comprehension of the viewed security policy document.

9. The method of claim 1, wherein enabling the creation of the security policy document further comprises enabling creation of a quiz associated with the security policy document.

10. The method of claim 8, wherein the received data includes user responses to the quiz.

11. A method for managing a security policy for one or more first computers in a network, comprising:
a) running a software program on a second computer in communication with the network;
b) enabling creation of a security policy document using the software program by enabling selection of security policies from a set of options; and
c) automatically configuring the security policy document to provide one or more technical controls for implementing the security policy on at least one first computer.

12. The method of claim 11, wherein the security policies selected from the set of options reside in a library in communication with the software program.

13. The method of claim 11, wherein two of the first computers operate in accordance with different operating systems.

14. The method of claim 11, wherein the technical controls comprise a format interpretable by at least one first computer.

15. The method of claim 11, wherein the security policy document is represented by a markup language.

16. The method of claim 11, further comprising distributing detect rules to at least one first computer.

17. The method of claim 16, further comprising electronically notifying an administrator when at least one first computer is out of compliance.

18. The method of claim 11, further comprising distributing the one or more technical controls to at least one first computer.

19. The method of claim 18, further comprising running a second software program on at least one first computer to allow at least one first computer to interpret the distributed technical controls.

20. The method of claim 19, wherein the second software program uses metacommands to convert the technical controls into instructions interpretable by an operating system running on at least one first computer.

21. The method of claim 11, further comprising receiving data relevant to compliance of at least one first computer with the one or more technical controls using the software program.

22. The method of claim 21, further comprising assessing the received data using a third software program.

23. The method of claim 22, wherein the third software program comprises a security management program.

24. The method of claim 21, further comprising verifying a degree of compliance of at least one first computer with the one or more technical controls by using the software program to assess the received data.

25. The method of claim 24, wherein the received data comprises compliance score data.

26. A method for managing a security policy for one or more users and one or more first computers in a network, comprising:
a) running a software program on a second computer in communication with the network;
b) creating a security policy document using the software program; and
c) automatically configuring the security policy document to create (i) a human-readable security policy document, and (ii) a machine-readable security policy document containing technical controls readable by at least one first computer.

27. The method of claim 26, further comprising allowing the users to view the human-readable security policy document via the network.

28. The method of claim 27, wherein allowing the users to view the human-readable security policy document comprises pre-selecting a group of users to view the security policy document.

29. The method of claim 27, further comprising electronically receiving data relevant to user viewing of the security policy document.

30. The method of claim 29, wherein the received data includes a timestamp denoting the time a user acknowledged viewing the security policy.

31. The method of claim 29, further comprising verifying a degree of user compliance with the security policy by using the software program to assess the received data.

32. The method of claim 31, wherein the received data includes quiz results indicative of the user comprehension of the viewed security policy document.

33. The method of claim 26, wherein creating the security policy document comprises selecting security policies from a set of options.

34. The method of claim 33, wherein the security policies selected from the set of options reside in a library in communication with the software program.

35. The method of claim 26, wherein the human-readable security policy document includes a quiz to test user comprehension of the security policy document.

36. The method of claim 26, further comprising electronically providing a quiz to assess user comprehension of the viewed security policy document.

37. The method of claim 26, wherein enabling the creation of the security policy document further comprises enabling creation of a quiz associated with the security policy document.

38. The method of claim 26, further comprising distributing the machine-readable security policy document to at least one first computer to implement the security technical controls thereon.

39. The method of claim 38, further comprising running a second software program on at least one first computer to allow at least one first computer to interpret the distributed technical controls.

40. The method of claim 39, wherein the second software program uses metacommands to convert the technical controls into instructions interpretable by an operating system running on at least one first computer.

41. The method of claim 38, further comprising receiving data relevant to compliance of at least one first computer with the technical controls using the software program.

42. The method of claim 41, further comprising assessing the received data using a third software program.

43. The method of claim 42, wherein the third software program comprises a security management program.

44. The method of claim 41, further comprising verifying a degree of compliance of at least one first computer with the technical controls by using the software program to assess the received data.

45. The method of claim 44, wherein the received data comprises compliance score data.

46. The method of claim 26, wherein two of the first computers operate in accordance with different operating systems.

47. The method of claim 26, wherein the technical controls comprise a format interpretable by at least one first computer.

48. The method of claim 47, wherein the security policy documents is represented by a markup language.

49. The method of claim 26, further comprising distributing detect rules to at least one first computer.

50. The method of claim 49, further comprising electronically notifying an administrator when at least one first computer is out of compliance.

51. A system for managing a security policy for one or more users and for one or more first computers in a network, comprising:
a) a first device containing a first program for creating a security policy document in both human-readable and machine-readable formats; and
b) a second device in communication with the first device and containing a second program for monitoring the security compliance of at least one first computer;
wherein at least one first computer contains a third program for receiving the machine-readable format of the security policy document.
